(19) United States
(12) Patent Application Publication
(10) Pub. No.: US 2024/0385812 A1
(43) Pub. Date: Nov. 21, 2024

(54) DATA PROCESSING METHOD AND APPARATUS, DEVICE, AND READABLE STORAGE MEDIUM

(71) Applicant: TENCENT TECHNOLOGY (SHENZHEN) COMPANY LIMITED, Shenzhen (CN)

(72) Inventor: Guanchao WEN, Shenzhen (CN)

(21) Appl. No.: 18/787,502

(22) Filed: Jul. 29, 2024

Related U.S. Application Data
(63) Continuation of application No. PCT/CN2023/098214, filed on Jun. 5, 2023.

(30) Foreign Application Priority Data
Aug. 22, 2022 (CN) 202211007832.7

(51) Int. Cl. G06F 8/34; G06F 8/20

(52) U.S. Cl. CPC G06F 8/34; G06F 8/20

(57) ABSTRACT

The present disclosure discloses a data processing method and apparatus, a device, and a readable storage medium. The method includes creating an execution instance corresponding to a target workflow, the execution instance comprising a pointing relationship between at least two function code blocks comprised in the target workflow, and the at least two function code blocks comprising a loop start function code block and a loop end function code block; obtaining a loop parameter corresponding to the loop start function code block; determining a function code block between the loop start function code block and the loop end function code block as a loop function code block according to the pointing relationship; and looping the loop function code block according to the loop parameter and the pointing relationship.

### RELATED APPLICATIONS

This application is a continuation of PCT Application No. PCT/CN2023/098214, filed on Jun. 5, 2023, which claims priority to Chinese Patent Application No. 2022110078327, entitled “DATA PROCESSING METHOD AND APPARATUS, DEVICE, AND READABLE STORAGE MEDIUM” filed with the China National Intellectual Property Administration on Aug. 22, 2022, which are both incorporated herein by reference in their entirety.

### FIELD OF THE TECHNOLOGY

This application relates to the field of computer technologies, and in particular, to data processing technologies.

### BACKGROUND OF THE DISCLOSURE

A workflow engine is a low-code technology to design processes or develop applications through graphical drag-and-drop, parameterized configuration, and other visual ways, which can reduce the threshold of programming and improve programming efficiency. With this low-code technology, various code features in programming such as condition determination, concurrency, and other functions can be implemented. Reducing programming development costs in a low-code mode allows objects with no programming experience to implement various code features through visual programming.

However, many current workflow engines only support simple serial execution of tasks, i.e., each application module (App) supports execution only once. Some scenarios where a loop traversal operation is performed based on an array or list cannot be supported, and ease of use and functionality of a workflow engine are poor.

### SUMMARY

Embodiments of this application provide a data processing method and apparatus, a device, and a readable storage medium, which can improve ease of use and functionality of a workflow engine.

One aspect of the embodiments of this application provides a data processing method, performed by a computer device. The method includes creating an execution instance corresponding to a target workflow, the execution instance comprising a pointing relationship between at least two function code blocks comprised in the target workflow, and the at least two function code blocks comprising a loop start function code block and a loop end function code block; obtaining a loop parameter corresponding to the loop start function code block; determining a function code block between the loop start function code block and the loop end function code block as a loop function code block according to the pointing relationship; and looping the loop function code block according to the loop parameter and the pointing relationship.

One aspect of the embodiments of this application provides a data processing method, performed by a computer device, including displaying a workflow editing page in response to a creation operation for a target workflow; displaying a workflow control tree formed by at least two function block controls on the workflow editing page in response to a selection and connection operation for the at least two function block controls, the at least two function block controls comprising a loop start function block control and a loop end function block control; setting a loop parameter for the loop start function block control in response to a trigger operation for the loop start function block control in the workflow control tree; creating a target workflow in response to a creation operation for the workflow control tree, and transmitting the target workflow to a workflow engine, the target workflow comprising function code blocks respectively corresponding to the at least two function block controls with a pointing relationship being determined according to a connection relationship between the at least two function block controls, and the at least two function code blocks comprising a loop start function code block corresponding to the loop start function block control and a loop end function code block corresponding to the loop end function block control; and transmitting a trigger request for the target workflow to the workflow engine in response to a trigger operation for the target workflow.

One aspect of the embodiments of this application provides a computer device, including: a processor, a memory, and a network interface the processor being connected to the memory and the network interface, the network interface being configured to provide a data communication network element, the memory being configured to store a computer program, and the processor being configured to invoke the computer program, to perform the method in the embodiment of this application.

One aspect of the embodiments of this application provides a non-transitory computer-readable storage medium. The computer-readable storage medium stores a computer program. The computer program is adapted to be loaded and executed by a processor, to perform the method in the embodiments of this application.

In embodiments of this application, an execution instance corresponding to a target workflow is created, where the execution instance includes a pointing relationship between at least two function code blocks included in the target workflow, and the at least two function code blocks include a loop start function code block and a loop end function code block. Then, a loop parameter corresponding to the loop start function code block is obtained, and a function code block between the loop start function code block and the loop end function code block is determined according to the pointing relationship, as a loop function code block. Finally, the loop function code block is cyclically executed according to the loop parameter and the pointing relationship. Accordingly, when an object (e.g., a user) creates a workflow by using a workflow engine, for a function code block that needs to be executed multiple times, the object only needs to place the function code block between a loop start function code block and a loop end function code block. The object does not need to have other programming experience, which reduces the threshold for using the workflow engine, and improves ease of use and functionality of the workflow engine.

### BRIEF DESCRIPTION OF THE DRAWINGS

FIG. 1 is a schematic diagram of a network architecture according to an embodiment of this application.

FIG. 2a is a schematic diagram of a scenario in which a target workflow is created according to an embodiment of this application.

FIG. 2b is a schematic diagram of a scenario in which a target workflow is executed according to an embodiment of this application.

FIG. 3 is a schematic flowchart of a data processing method according to an embodiment of this application.

FIG. 4 is a flowchart of web page callback trigger request processing according to an embodiment of this application.

FIG. 5 is a schematic flowchart of executing a target application instruction according to an embodiment of this application.

FIG. 6 is a schematic diagram of a pointing relationship of a workflow according to an embodiment of this application.

FIG. 7 is a schematic flowchart of a data processing method according to an embodiment of this application.

FIG. 8 is a schematic diagram of an execution instance message queue according to an embodiment of this application.

FIG. 9 is a schematic diagram of a function block instance queue according to an embodiment of this application.

FIG. 10 is a schematic diagram of a global variable data structure of a memory during execution of a workflow according to an embodiment of this application.

FIG. 11 is a schematic diagram of an index determining scenario according to an embodiment of this application.

FIG. 12 is a schematic diagram of an index determining scenario according to an embodiment of this application.

FIG. 13 is a schematic flowchart of a data processing method according to an embodiment of this application.

FIG. 14a is an overall schematic flowchart of an embodiment of loop workflow execution according to an embodiment of this application.

FIG. 14b is another overall schematic flowchart of an embodiment of loop workflow execution according to an embodiment of this application.

FIG. 15 is a schematic structural diagram of a data processing apparatus according to an embodiment of this application.

FIG. 16 is a schematic structural diagram of a computer device according to an embodiment of this application.

FIG. 17 is a schematic structural diagram of another data processing apparatus according to an embodiment of this application.

FIG. 18 is a schematic structural diagram of another computer device according to an embodiment of this application.

### DESCRIPTION OF EMBODIMENTS

The technical solutions in embodiments of this application are clearly and completely described in the following with reference to the accompanying drawings in the embodiments of this application. Apparently, the described embodiments are merely some rather than all of the embodiments of this application. All other embodiments obtained by a person of ordinary skill in the art based on the embodiments of this application without making creative efforts shall fall within the protection scope of this application.

For ease of understanding, the following first describes related concepts used in this application:

App: refers to an application module that encapsulates some common functions or interface services, which may be referred to as a function code block. An App may be used as an atomic task, and is the most basic execution unit in a workflow.

App instance: An App may be executed for multiple times. Each execution (different parameters) generates an instance. This instance is an App instance, or may be referred to as a function block instance. The App instance is specific instantiation of the App. The difference between the two is that the App is a template and uses a default parameter. The App instance uses a specific App template and uses a specific parameter. A relationship between the two is similar to a class and an object in object-oriented programming.

For loop body: is similar to a For loop code segment in codes, and Apps in the loop body are traversed and executed N times in sequence.

For loop start App: may be referred to as a loop start function code block. The App indicates that a process starts to enter a For loop body. The App may be set with a quantity of loops.

For loop end App: may be referred to as a loop end function code block, and the App represents an end position of a loop body, that is, a range of the For loop body is from a For loop start App to a For loop end App, and after entering the For loop end App, the loop body ends after a quantity of loops is met.

Trigger: is a start App of triggering workflow running, including: timer, WebHook (web page callback), etc.

Credential: mainly refers to some important parameter information, including account and password, token, key, and the like. Different Apps may correspond to different credential parameters.

Workflow: is a model that represents an actual service by using a flowchart, and a specific work scenario is completed in an automated mode.

Workflow engine: The workflow engine is a routing controller of a process. One process corresponds to one service that is actually transferred. An execution route of the process is controlled by current App instance data. Transfer rules of the process are specified during process definition. Generally, these transfer rules are determined according to variable expressions of current data of an App instance. A task of a workflow engine is to parse these variable expressions according to a context environment of process execution to find out the next process execution direction.

Workflow definition language: refers to a syntax specification configured for designing a workflow. In this specification, a workflow is defined in the simple and general mode JSON.

Path syntax expression: Input or output data for each App instance in a workflow can be indexed by paths such as {{AppInstId.data.0.name}}, implementing dynamic data parsing and reference at runtime.

Execution task: refers to a specific workflow instance and may also be referred to as an execution instance. When a workflow is triggered to execute, a specific execution task is generated, and the workflow obtains execution tasks with different results according to different input parameters.

Message queue: is a first-in-first-out data structure.

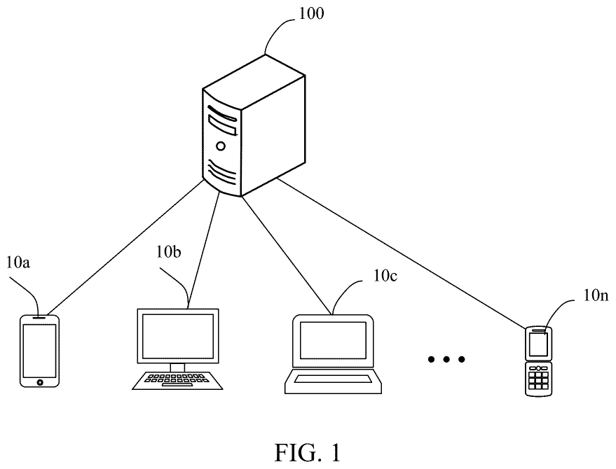

Referring to FIG. 1, FIG. 1 is a schematic diagram of a network architecture according to an embodiment of this application. As shown in FIG. 1, the network architecture may include a service server 100 and a terminal device cluster. The terminal device cluster may include multiple terminal devices. As shown in FIG. 1, the terminal device cluster may specifically include a terminal device 10a, a terminal device 10b, a terminal device 10c, . . . , and a terminal device 10n. As shown in FIG. 1, the terminal device 10a, the terminal device 10b, the terminal device 10c, . . . , and the terminal device 10n may separately communicate with the service server 100 by using a network, so that each terminal device may perform data interaction with the service server 100 by using the network, so that each terminal device may receive service data from the service server 100.

An application client may be installed on each terminal device in the terminal cluster shown in FIG. 1. When the application client runs in each terminal device, data interaction may be separately performed with the service server 100 shown in FIG. 1. The application client may be an application client of an application having a data information function such as a programming application, a game application, a video editing application, a social application, an instant messaging application, a livestreaming application, a short video application, a video application, a music application, a shopping application, a novel application, a payment application, a browser, and the like that displays a text, an image, an audio, and a video. The application client may be an independent client, or may be an embedded subclient integrated in a client (such as a social client or a game client), which is not limited herein.

As shown in FIG. 1, any terminal device in the terminal device cluster may display a workflow editing page by running the application client. By using the terminal device 10a as an example, an application client running on the terminal device 10a may perform, by using a workflow editing page displayed on the terminal device 10a, a selection and connection operation on a function block control displayed on the workflow editing page, so as to construct a workflow control tree. One function block control corresponds to one function code block. The terminal device 10a determines, based on a connection relationship between function block controls in the workflow control tree, a pointing relationship between function code blocks corresponding to the function block controls, so as to generate a target workflow. The terminal device 10a transmits the target workflow to the service server 100, and the service server 100 stores the target workflow. When receiving a trigger request for the target workflow, the terminal device 10a executes the target workflow.

As shown in FIG. 1, after receiving the trigger request for the target workflow, the service server 100 creates an execution instance corresponding to the target workflow, where the execution instance includes a pointing relationship between at least two function code blocks included in the target workflow, and the at least two function code blocks may include a loop start function code block and a loop end function code block. After the service server 100 creates a loop start function block instance corresponding to the loop start function code block, the service server 100 pushes the loop start function block instance to a function block instance queue. When the loop start function block instance in the function block instance queue is successfully executed, the service server 100 obtains a loop parameter corresponding to the loop start function code block. Function block instances in the function block instance queue will be executed sequentially. The service server 100 determines, according to the foregoing pointing relationship, a function code block between the loop start function code block and the loop end function code block as a loop function code block, and then cyclically executes the loop function code block according to the loop parameter, the function block instance queue, and the pointing relationship. In short, the loop start function code block and the loop end function code block jointly provide a loop function for the target workflow. A function code block that needs to be executed for multiple times needs to be located only between the loop start function code block and the loop end function code block. For an object (such as a user), a function block control corresponding to the function code block that needs to be executed for multiple times only needs to be dragged for connection between a loop start function block control corresponding to the loop start function code block and a loop end function block control corresponding to the loop end function code block. Therefore, a use object requires no additional programming experience to create a workflow with loop functionality.

The foregoing network connection between the service server 100 and each terminal device in the terminal device cluster is not limited to a connection mode, and may be directly or indirectly connected in a wired communication mode, or may be directly or indirectly connected in a wireless communication mode, or may be connected in another connection mode, which is not limited in this application.

The data processing method provided in the embodiment of this application may be performed by a computer device, and the computer device includes but is not limited to the service server 100 and the terminal device. The server may be an independent physical server, or may be a server cluster or a distributed system formed by multiple physical servers, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The foregoing terminal may be a smartphone, a tablet computer, a notebook computer, a desktop computer, an intelligent voice interaction device, a smart home appliance, an in-vehicle terminal, or the like, but is not limited thereto.

The embodiments of this application may be applied to various scenarios, including but not limited to a cloud technology, artificial intelligence, smart transport, and aided driving.

When the embodiments of this application are applied to a specific product or technology, for related data such as a related workflow, a user's permission or consent needs to be obtained, and related data collection, use, and processing need to comply with relevant laws and standards of a relevant country and region.

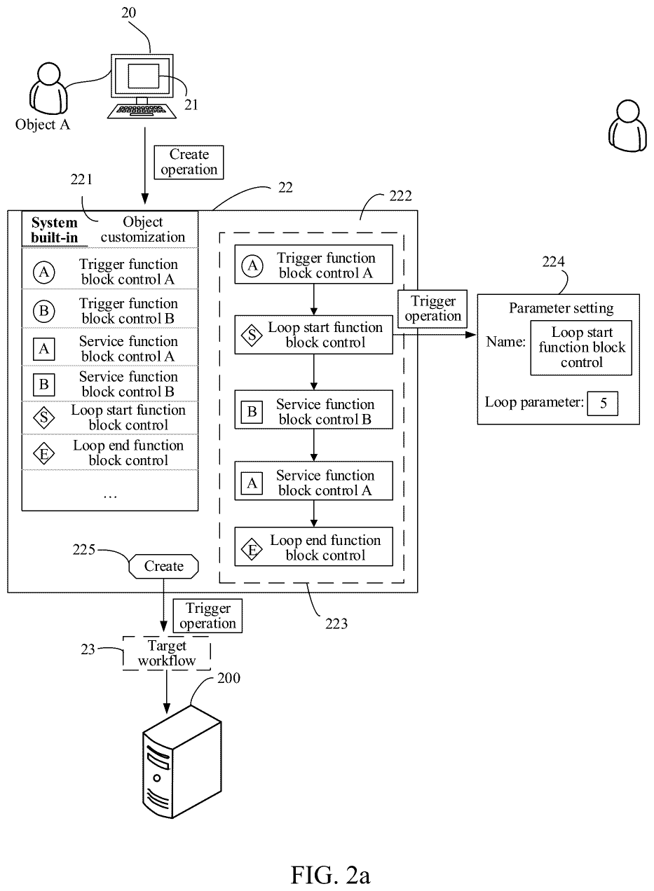

For ease of understanding the foregoing process, refer to FIG. 2a and FIG. 2b. A terminal device 20 shown in FIG. 2a and FIG. 2b may be any terminal device in the foregoing terminal device cluster shown in FIG. 1. For example, the terminal device 20 may be the terminal device 10a. A service server 200 shown in FIG. 2a and FIG. 2b may be the service server 100 shown in FIG. 1.

Referring to FIG. 2a first, FIG. 2a is a schematic diagram of a scenario in which a target workflow is created according to an embodiment of this application. As shown in FIG. 2a, an application client 21 is integrated and installed in the terminal device 20, and the application client 21 may be configured to provide a workflow design function for a use object (for example, a user). It is assumed that a use object of the terminal device 20 is an object A, and the object A does not have programming experience but wants to design a service model that has a service function required by the object A. Then, a target workflow may be designed by using a workflow design function provided by the application client 21 and in a visual drag-and-drop programming mode, and then the target workflow is triggered, so as to implement a corresponding service function. As shown in FIG. 2a, when the application client 21 runs in the terminal device 20, the object A may perform a creation operation on the target workflow by using the application client 21. The terminal device 20 may respond to the creation operation on the target workflow, and display a workflow editing page 22. The workflow editing page 22 may include a control selection area 221 and a canvas area 222. A function block control is displayed in the control selection area 221, and one function block control corresponds to one function code block, so as to implement a specific function. In the control selection area 221, a default function block control built in the system can be displayed, or a function block control customized by an object can be displayed.

Types of function block controls may be mainly classified into three types: One is a trigger function block control, which is corresponding to a trigger function code block, where the trigger function code block is mainly a start function code block of a workflow, and different trigger function code blocks may implement different trigger modes of the workflow. The second is a service function block control, which corresponds to a service function code block, and the service function code block is a function code block in which a relatively common service operation is encapsulated. The third is a logical function block control, which corresponds to a logical function code block. The logical function code block mainly relates to a process relationship of a workflow. For example, for a function code block between a loop start function code block corresponding to a loop start function block control and a loop end function code block corresponding to a loop end function block control, loop execution needs to be performed.

The canvas area 222 is an area configured for supporting the object A to design a workflow control tree. The object A may select a function block control from the control selection area 221, then drag the selected function block control into the canvas area 222, and perform a connection operation with another function block control to obtain a workflow control tree 223. As shown in FIG. 2a, the workflow control tree 223 designed by the object A may sequentially include a trigger function block control A, a loop start function block control, a service function block control B, a service function block control A, and a loop end function block control according to a connection relationship. By default, a quantity of execution of a function code block corresponding to a function block control is 1, but a function code block corresponding to a function block control that is located between a loop start function block control and a loop end function block control needs to be cyclically executed, and a quantity of loops is determined by a loop parameter corresponding to the loop start function block control.

For a parameter that needs to be used when the function code block is executed, the object A may perform, in the canvas area 222, a trigger operation on the function code block control, so as to enter an editing text box corresponding to the function code block control for editing. For example, when the object A performs a trigger operation on the loop start function block control, the terminal device 20 may display a loop edit text box 224. Then, the object A may set a loop parameter in the loop edit text box 224, and the terminal device 20 responds to an input parameter of the loop start function block control 225 to determine that the loop parameter of the loop start function block control is 5.

When setting a parameter required by each function block control, the object A may perform a trigger operation on a creation control 225 displayed in the canvas area 222, so as to implement a creation operation on the workflow control tree 223. The terminal device may create a target workflow 23 in response to the creation operation on the workflow control tree 223, and then transmit the target workflow 23 to a workflow engine. The workflow engine refers to an engine system configured for executing a workflow, and may be deployed in the service server 200, that is, the terminal device 20 transmits the generated target workflow 23 to the service server 200, and the service server 200 correspondingly stores the target workflow 23.

In addition, in a running process, a function code block may need to use credential information (that is, information such as account and password). For example, a database operation function code block needs to use credential information such as account and password related to a database. For ease of management, the application client 21 further has a credential management function, that is, creates and saves credential information that can be used by an object. In short, when the object A needs to use credential information, before the creation operation for the target workflow needs to be performed, a credential management operation needs to be performed first. The terminal device responds to the credential management operation to display a credential creation page. The object A may create, by using the credential creation page, the credential information that needs to be used. The terminal device saves the credential information that is created by the object A. A specific creation procedure may be determined according to an actual situation, and this application sets no limitation thereto.

Further, referring to FIG. 2b, FIG. 2b is a schematic diagram of a scenario in which a target workflow is executed according to an embodiment of this application. As shown in FIG. 2b, the object A performs a trigger operation on a target workflow in a trigger mode corresponding to a trigger function code block A, and the terminal device 20 generates a trigger request 24 in response to the trigger operation. After the terminal device 20 transmits the trigger request 24 to the service server 200, the service server 200 creates an execution instance 25 corresponding to the target workflow 23 according to the trigger request 24. The target workflow 23 may sequentially include a trigger function code block A, a loop start function code block, a service function code block B, a service function code block A, and a loop end function code block. Function code blocks included in the target workflow 23 are in a one-to-one correspondence with the function block controls shown in FIG. 2a. The execution instance 25 is a specific implementation task of the target workflow 23. Different execution instances of the target workflow 23 correspond to different parameters, and resulting execution results may be different.

The service server 200 determines a pointing relationship between function code blocks according to the execution instance 25, and then creates and executes a trigger function block instance corresponding to the trigger function code block A starting from the first function code block, that is, the trigger function code block A. A process of creating and executing the trigger function block instance may be as follows: The service server 200 first creates the trigger function block instance corresponding to the trigger function code block A, and then pushes the trigger function block instance into a function block instance queue for execution. Function block instances in the function block instance queue are sequentially extracted and executed. After the service server 200 extracts the trigger function block instance from the function block instance queue, the service server 200 executes the trigger function block instance. After execution is completed, the service server 200 determines, according to the pointing relationship, a next function code block (that is, the loop start function code block) that the trigger function code block A points to, and then continues to create and execute a function block instance corresponding to the next function code block. When creating and executing a loop start function block instance corresponding to the loop start function code block, the service server 200 obtains a loop parameter corresponding to the loop start function block instance, that is, in the foregoing embodiment shown in FIG. 2a, the object A edits the loop parameter entered in the text box corresponding to the loop start function block control by using the loop start function block control. Then, for the function code blocks between the loop start function code block and the loop end function code block, that is, the service function code block B and the service function code block A, the service server 200 uses the service function code block B and the service function code block A as loop function code blocks for loop execution. As shown in FIG. 2a, it is assumed that the loop parameter is 5. After creating and executing the service function block instance B for the first time, the service server 200 further needs to loop, and then creates and executes the service function block instance B for the second time, creates and executes the service function block instance A, and then continues to loop until creating and executing the service function block instance B for the fifth time, creates and executes the service function block instance A, and then the service server 200 executes the loop end function block instance.

The loop end function block instance is created after the service function block instance A is executed for the first time, that is, when the service server 200 creates, according to the pointing relationship, a function block instance corresponding to a next function code block to which the service function code block A points, if a function block instance corresponding to the next function code block to which the service function code block A points is the loop end function block instance, the service server 200 temporarily caches the loop end function block instance to perform the foregoing loop process.

As shown in FIG. 2b, the service server 200 creates an execution instance table 26 corresponding to the execution instance 25, where the execution instance table 26 is configured for recording an execution status of the execution instance 25. After execution of the execution instance 25 is completed, the service server 200 may transmit the execution instance table 26 to the terminal device 20, and the object A may query an execution result corresponding to each function code block based on the execution instance table 26.

The foregoing execution process of the workflow may also be directly executed in the terminal device, which is not limited herein in this application.

Accordingly, by using the method in this embodiment of this application, loop execution of a function code block may be implemented by using a loop start function code block and a loop end function code block, and an object does not need to have additional programming experience, thereby improving ease of use and feasibility of a workflow engine.

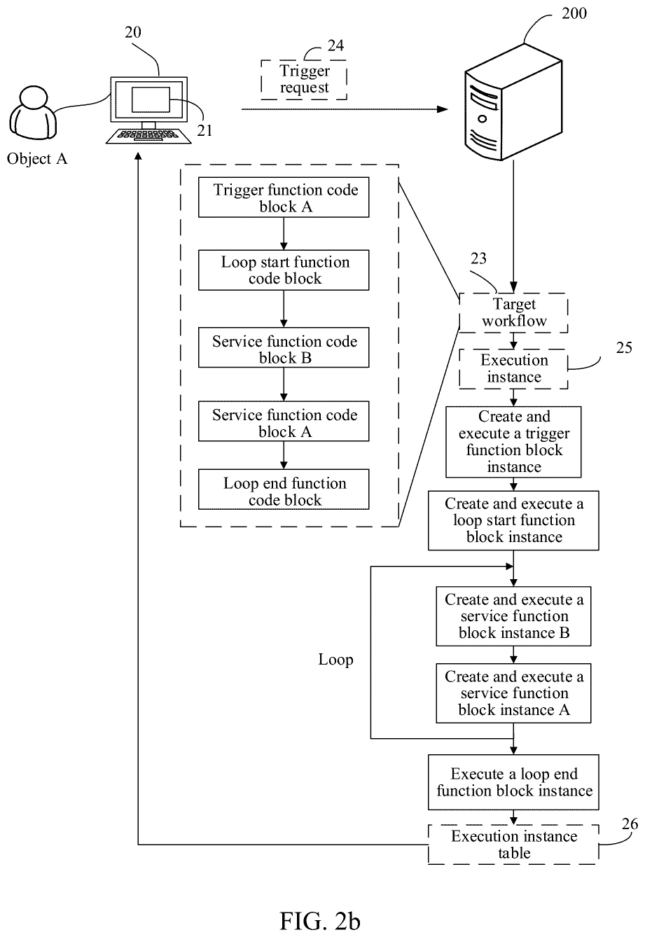

Further, referring to FIG. 3, FIG. 3 is a schematic flowchart of a data processing method according to an embodiment of this application. The method may be performed by a computer device. The computer device may be the service server 100 shown in FIG. 1, or may be any terminal device, such as the terminal device 10c, in the terminal device cluster shown in FIG. 1. The following uses an example in which the method is performed by a computer device for description. The data processing method may include at least the following operations S101 to S104:

Operation S101: Create an execution instance corresponding to a target workflow; the execution instance including a pointing relationship between at least two function code blocks included in the target workflow; and the at least two function code blocks including a loop start function code block and a loop end function code block.

Specifically, a workflow is a service model that includes at least two function code blocks, and may be understood as a process with a service function. One function code block may be referred to as one node of a workflow, and there is a pointing relationship between at least two function code blocks. For example, the workflow may be represented as node A→node B→node C. The node A, the node B, and the node C each represent one function code block. The node A points to the node B and the node B points to the node C. When executing the workflow, the computer device first executes the node A, then executes the node B, and finally executes the node C.

Specifically, a start function code block in a workflow is generally a trigger function code block, which may also be referred to as a trigger APP. Different trigger APPs may trigger the workflow in different modes to run. For details, refer to the following Table 1.

TABLE 1

| Trigger | |
|---|---|
| type | Description |
| WebHook | Using the webhook trigger, the computer |
| (web page | device automatically generates a unique |
| callback) | webhook for a current workflow, that is, a |
| trigger | uniform resource locator (URL) callback |
| | address. Execution of the workflow can |
| | be triggered by using the address. |
| Instruction | For a default account assistant of the |
| trigger | computer device, a corresponding instruction |
| | (one instruction corresponds to one |
| | workflow) message may be |
| | transmitted to trigger execution |
| | of a workflow by using callback. |
| Cron | Runtime of a loop can be set using the |
| (scheduled | Cron trigger. Workflow execution is |
| task) | triggered automatically at specified time. |
| trigger | |

Specifically, the computer device may receive a trigger request for the target workflow, and create an execution instance corresponding to the target workflow in response to the trigger request. Because trigger modes are different, types of trigger requests received by the computer device are different. When the trigger request is a web page callback trigger request, a specific implementation process in which the trigger request for the target workflow is received and the execution instance corresponding to the target workflow is created may be: receiving the web page callback trigger request for the target workflow, and obtaining a target token from the web page callback trigger request; obtaining the target workflow in a workflow repository according to the target token; and creating the execution instance corresponding to the target workflow according to a request parameter included in the web page callback trigger request.

The web page callback trigger request may be a HyperText Transfer Protocol (HTTP) request. When a start node of the target workflow is a WebHook trigger, the computer device may create and allocate a unique token to the target workflow to form a unique WebHook URL request address. Each WebHook URL corresponds to one workflow. When a POST (a request mode) request is initiated for this URL, a workflow engine application programming interface (API) service installed in the computer device receives an HTTP request, and obtains a corresponding workflow for execution.

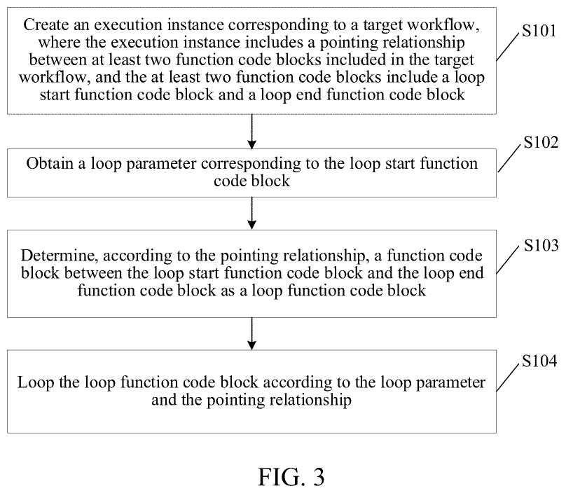

For ease of understanding, refer to FIG. 4 together. FIG. 4 is a flowchart of web page callback trigger request processing according to an embodiment of this application. As shown in FIG. 4, a process of web page callback trigger request processing mainly includes the following operations:

Operation S41: The computer device receives a web page callback trigger request.

Specifically, the computer device receives the web page callback trigger request for the target workflow, where the web page callback trigger request is an HTTP request transmitted to the computer device when the foregoing POST request is performed on the URL address corresponding to the workflow.

Operation S42: Obtain a token.

Specifically, the computer device obtains a target token from the web page callback trigger request. The web page callback trigger request carries the token. The computer device parses the web page callback trigger request, and may obtain the token.

Operation S43: Search for a corresponding workflow.

Specifically, the computer device may obtain the target workflow from a workflow repository according to the target token. The workflow repository is configured for storing a workflow. One token is bound to a unique workflow. Therefore, only the workflow bound to the token needs to be obtained.

Operation S44: Determine whether to enable the workflow.

Specifically, if the workflow is successfully enabled, operation S45 is performed. If the workflow fails to be enabled, operation S49 is performed.

Operation S45: Obtain a request parameter.

Specifically, a POST request parameter is obtained.

Operation S46: Construct an execution record.

Specifically, an execution record table is created, where the execution record table may record information such as a process relationship and execution time of a workflow.

Operation S47: The computer device initiates execution of the workflow asynchronously.

Specifically, the computer device may create an execution instance corresponding to the target workflow according to the request parameter included in the web page callback trigger request, and then execute the execution instance.

Operation S48: The computer device generates an execution identifier and ends the process.

Specifically, one execution instance may be identified by using a unique execution identifier. The computer device may first return the execution identifier to the terminal device, and then the terminal device may query an execution result of the execution instance by using the execution identifier. In this case, the process of triggering the workflow by using the web page callback trigger request ends.

Operation S49: Prompt an error and end the process.

Specifically, the computer device returns the error prompt to the terminal device.

In some embodiments, when the trigger request is an instruction request, a specific implementation process in which the trigger request for the target workflow is received and the execution instance corresponding to the target workflow is created may be: obtaining, by using a callback address, the instruction request transmitted by a first object, and decrypting the instruction request to obtain a trigger instruction and a trigger parameter; obtaining the target workflow according to the trigger instruction, and verifying a trigger permission of the first object according to the trigger parameter; and creating the execution instance corresponding to the target workflow if the trigger permission of the first object is a qualified permission.

The instruction request may be a request generated by transmitting a trigger instruction to a target account. When the start node of the target workflow is an instruction trigger, a target account may be applied for and registered on a target application, and a callback address of the target account is enabled to point to a callback API (interface) of the workflow engine installed in the computer device. Subsequently, all messages transmitted to the target account are forwarded to the following callback API interface by using the target application. The target application may be an application that has an instant session function. The trigger instruction may be created by the object itself, and trigger of one workflow corresponds to one unique trigger instruction.

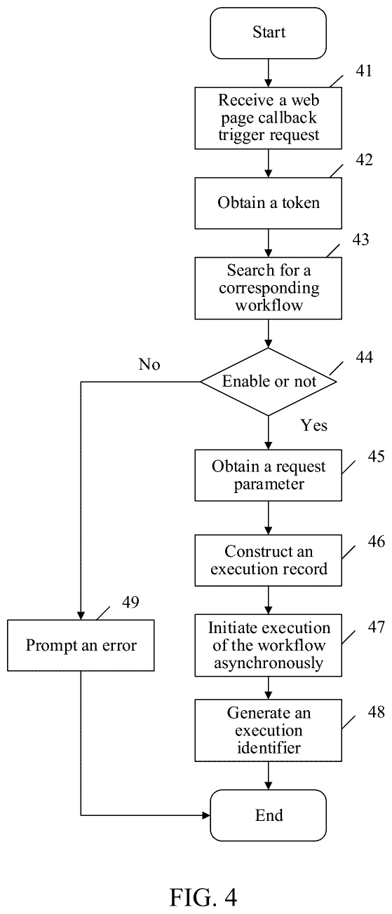

For ease of understanding, referring to FIG. 5, FIG. 5 is a schematic flowchart of executing a target application instruction according to an embodiment of this application. As shown in FIG. 5, a target application is an application that has an instant session function, and may be integrated and installed in a terminal device. A process of executing a target application instruction mainly includes the following operations:

Operation S51: A computer device configures a target account and a callback address.

Specifically, the computer device may be integrated and installed with a workflow engine, and may further provide an API service corresponding to a workflow engine. The computer device may configure the target account and the callback address by using the API service corresponding to the workflow engine. The target account is configured for receiving an instruction transmitted by the terminal device, and the callback address points to a callback API of the workflow engine, and may call the API service of the workflow engine.

Operation S52: The computer device registers the configured target account and callback address in the target application.

Specifically, after the target account is registered successfully in the target application, a subsequent object account that is logged in to the target application in the terminal device may transmit a message to the target account, and all messages received by the target account are forwarded to the callback API by using the callback address in the target application.

Operation S53: The terminal device creates an instruction.

Specifically, the terminal device may create a trigger instruction, and a name of each trigger instruction is unique, and is in a one-to-one correspondence with a current workflow. In addition, the terminal device may authorize the instruction to an object account of a specific object, and only an object account with a permission can view the instruction and execute the instruction.

In some embodiments, an object account logged in to the target application in the terminal device may transmit a system query instruction to the target account, so as to query whether the object account has a permission to use the instruction.

Operation S54: The terminal device transmits the instruction to the computer device, and the computer device records the instruction and associates it with a corresponding workflow.

Specifically, the computer device records the trigger instruction created by the terminal device, and associates it with the corresponding workflow.

Operation S55: The terminal device initiates a message that carries the instruction to the target account.

Specifically, after a first object logs in to the object account by using the target application running on the terminal device, the first object may initiate a message that carries the instruction to the target account.

Operation S56: After receiving the message by using the target account, the target application encrypts and signs the message to obtain an encrypted message, and transmits the encrypted message to the computer device.

Operation S57: The computer device receives, by using the callback address, the encrypted message transmitted by the target application.

Operation S58: The computer device decrypts the encrypted message to obtain the instruction and a parameter.

Specifically, after obtaining, by using the callback address, the instruction request that is transmitted by the first object and that carries the encrypted message, the computer device decrypts the encrypted message in the instruction request to obtain the instruction (that is, the trigger instruction) and the parameter (that is, a trigger parameter). The first object is an object that has logged in by using the object account.

Operation S59: The computer device obtains the workflow associated with the instruction.

Specifically, the computer device may obtain the target workflow according to the instruction (that is, the trigger instruction), that is, trigger the workflow associated with the instruction.

Operation S510: The computer device determines whether the first object has an instruction permission.

Specifically, the computer device may verify a trigger permission of the first object according to the trigger parameter, that is, determine whether the object account transmitting the message has the instruction permission. If the trigger permission is a qualified permission, the first object has the instruction permission, and the target workflow can be triggered. Therefore, operation S512 is performed. If there is no instruction permission, operation S511 is performed.

Operation S511: The computer device transmits a no permission prompt to the terminal device.

Operation S512: The computer device creates an execution instance corresponding to the workflow.

Operation S513: The computer device executes the execution instance to obtain an execution result.

Operation S514: The computer device returns the execution result to the terminal device.

In some embodiments, when the trigger request is a timer trigger request, a specific implementation process in which the trigger request for the target workflow is received and the execution instance corresponding to the target workflow is created may be: receiving the timer trigger request for the target workflow, and obtaining a specified execution time from the timer trigger request; and creating the execution instance corresponding to the target workflow when system time is the same as the specified execution time.

The timer trigger request may be a request generated by providing a Cron periodic task trigger. The Cron trigger uses the syntax of Linux crontab (a programming language). After specified time, an execution instance corresponding to the target workflow is created for execution.

Operation S102: Obtain a loop parameter corresponding to the loop start function code block.

Specifically, for the at least two function code blocks in the execution instance, the computer device first obtains the first function code block (usually the foregoing trigger function code block), creates a start function block instance corresponding to the first function code block, and pushes the start function block instance to the function block instance queue. The first function code block is not generally a loop start function code block. The function block instance queue is configured for storing a function block instance waiting to be executed. The computer device sequentially executes the function block instances in the function block instance queue. A first-in-first-out principle is generally used in an execution sequence. After the computer device extracts and executes the start function block instance from the function block instance queue, the computer device may determine, according to the pointing relationship, a function code block list to which the first function code block points, where the function code block list includes one or more function code blocks to which the first function code block points. In this case, the computer device sequentially creates function block instances respectively corresponding to the one or more function code blocks, and then pushes them to the function block instance queue for execution.

After each function block instance associated with the execution instance is successfully executed from the function block instance queue, the computer device determines whether a function code block corresponding to the function block instance is a loop start function code block. If the function code block corresponding to the function block instance is not a loop start function code block, the computer device continues to query, according to the pointing relationship, a function code block list to which the function code block corresponding to the function block instance points. If the function code block list to which the function code block points is found, the computer device continues to create a function block instance corresponding to the function code block included in the function code block list, and then continues to push the created function block instance to the function block instance queue for execution. For example, it is assumed that the target workflow is node A→node B→node C→ . . . , and the node A is corresponding to the first function code block in the workflow. After the function block instance corresponding to the node A is extracted and executed from the function block instance queue, the computer device creates a function block instance corresponding to the node B. It is assumed that the node B is corresponding to a service function code block, the computer device pushes the function block instance corresponding to the node B to the function block instance queue for execution. After the function block instance corresponding to the node B is extracted and executed from the function block instance queue, the computer device continues to create a function block instance corresponding to the node C, and so on.

Specifically, when the computer device creates a loop start function block instance corresponding to the loop start function code block, the computer device first pushes the loop start function block instance to the function block instance queue. When the loop start function block instance in the function block instance queue is successfully executed, the computer device first obtains a loop parameter corresponding to the loop start function code block, where the loop parameter is a quantity of For loop traversal times, and is configured for representing a quantity of times that the following loop function code block needs to be cyclically executed.

Operation S103: Determine, according to the pointing relationship, a function code block between the loop start function code block and the loop end function code block as a loop function code block.

Specifically, a quantity of loop function code blocks may be one or more. It is assumed that a node S corresponds to the loop start function code block, a node E corresponds to the loop end function code block, and a node D and a node F each correspond to one service function code block. In the target workflow, node S→node D→node F→node E, and the service function code blocks corresponding to the node D and the node F are loop function code blocks, and need to be cyclically executed.

Operation S104: Cyclically execute the loop function code block according to the loop parameter and the pointing relationship.

That is, the computer device may cyclically execute the foregoing loop function code block according to the loop parameter, the function block instance included in the function block instance queue, and the pointing relationship.

Specifically, assuming that the loop parameter is N, and N is a positive integer greater than or equal to 1, the computer device performs N rounds of iteration on the loop function code block according to the function block instance queue and the pointing relationship. In a kth round of iteration on the loop function code block, the computer device may first determine, according to the pointing relationship, a list of to-be-executed function code blocks to which the loop start function code block points. k is a positive integer less than or equal to N.

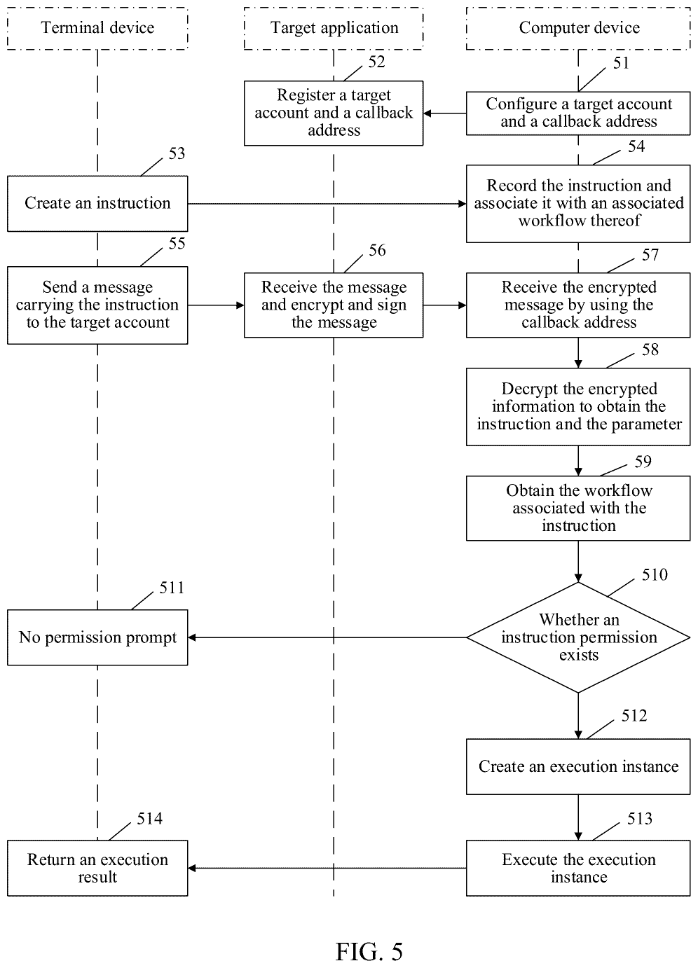

For ease of understanding, refer to FIG. 6 together. FIG. 6 is a schematic diagram of a pointing relationship of a workflow according to an embodiment of this application. It is assumed that a node s corresponds to the loop start function code block, a node e is corresponding to the loop end function code block, and a node a, a node b, a node c, and a node d are each corresponding to one service function code block. Because the node a, the node b, the node c, and the node d are located between the node s and the node e, the service function code blocks corresponding to the node a, the node b, the node c, and the node d are loop function code blocks. As shown in FIG. 6, the node s points to the node a and the node b, that is, a list of to-be-executed function code blocks to which the node s points includes the node a and the node b. In this case, the loop function code blocks form two branches, that is, [node a, node c] and [node b, node d]. Execution processes of the node a and the node b do not affect each other. Correspondingly, the execution processes of the two branches do not affect each other. Therefore, execution of the two branches may be performed simultaneously in each round of iteration. In other words, the computer device may directly create together to-be-executed function block instances respectively corresponding to the function code blocks included in the list of to-be-executed function code blocks, that is, create together the to-be-executed function block instances respectively corresponding to the node a and the node b, and then sequentially push the to-be-executed function block instances to the function block instance queue.

Then, the computer device executes a target to-be-executed function block instance corresponding to a target to-be-executed function code block in the function block instance queue, where the target to-be-executed function code block is a function code block in the list of to-be-executed function code blocks. In this case, if the list of to-be-executed function code blocks does not include the loop end function code block, when execution of the target to-be-executed function block instance in the function block instance queue succeeds, the computer device continues to determine, according to the pointing relationship, a new list of to-be-executed function code blocks to which the target to-be-executed function code block points until it is determined that a kth round of iteration on the loop function code blocks is completed. If k is less than N, the computer device continues to perform a (k+1)th round of iteration on the loop function code blocks.

For ease of understanding of the foregoing process, referring to FIG. 6, it is assumed that in the kth round of iteration, the computer device creates the function block instances respectively corresponding to the node a and the node b to which the loop start function code block points, and the computer device pushes the function block instances corresponding to the node a and the node b together to the function block instance queue. After the computer device obtains and executes the function block instance corresponding to the node a from the function block instance queue, the computer device determines, according to the pointing relationship, a function code block list to which the node a points. In this case, a next-batch function code block list includes only the node c. The computer device creates a function block instance corresponding to the node c, and then pushes the function block instance to the function block instance queue. After the computer device obtains and executes the function block instance corresponding to the node c from the function block instance queue, the computer device determines, according to the pointing relationship, a function code block list to which the node c points and, so on. As such, all nodes included in the branch starting from the node a are executed. Similarly, a node included in the branch starting from the node b is also executed. Therefore, in the process of performing the kth round of iteration, all loop function code blocks are executed according to the pointing relationship until the kth round of iteration is completed.

In some embodiments, if a new list of to-be-executed function code blocks includes the loop end function code block, a loop end function block instance queue is queried. If the loop end function block instance queue is an empty queue, a loop end function block instance corresponding to the loop end function code block is created, and the loop end function block instance is pushed to the loop end function block instance queue. If the loop end function block instance queue is not an empty queue, the computer device may no longer create the loop end function block instance corresponding to the loop end function code block.

The loop function code block may contain multiple branches, and end nodes of these branches ultimately point to the loop end function code block. When the computer device determines that a list of to-be-executed function code blocks includes the loop end function code block, a current branch of the loop function code block is completed in this round of iteration. In addition, for the loop end function code block, because loop execution does not need to be performed, the computer device only needs to create the loop end function code block instance corresponding to the loop end function code block once. However, the loop end function code block instance is to be executed after loop execution of the loop function code block is completed. Therefore, when the computer device determines that a list of to-be-executed function code blocks includes the loop end function code block, the computer device queries the loop end function block instance queue, where the loop end function block instance queue is configured for temporarily storing the loop end function code block instance created in the loop end execution process. If the computer device finds that the loop end function block instance queue is an empty queue, the computer device has not created the loop end function code block instance corresponding to the loop end function code block, and in this case, the computer device creates the loop end function code block instance, and pushes the loop end function block instance to the loop end function block instance queue. If the computer device finds that the loop end function block instance queue is not an empty queue, the computer device has created the loop end function code block instance corresponding to the loop end function code block.

For ease of understanding, references may be further made to FIG. 6. As shown in FIG. 6, for the branch [node a, node c], when execution of the node c is completed, the computer device determines that a next node to which the node c points is the node e. Because the node e corresponds to the loop end function code block, the computer device queries the loop end function block instance queue. Assuming that the loop end function block instance queue is an empty queue, the computer device creates a loop end function block instance corresponding to the node e, and pushes the loop end function block instance to the loop end function block instance queue for temporary storage. If the loop end function block instance queue already stores the loop end function block instance, the computer device does not need to create the loop end function block instance corresponding to the node e. In this case, the computer device may determine that execution of the branch [node a, node c] in this round of iteration ends. That is, after the computer device completes execution of a node, if it is determined that a next node to which the node points is a loop end function code block, it may be determined that execution of a branch that uses the node as a tail node is completed in this round of iteration, but it cannot be directly determined that this round of iteration of the loop function code block is completed.

In some embodiments, the computer device may determine, by detecting execution data of an execution instance, whether execution of the kth round of iteration is completed. The execution data may include a quantity of instances in queue and a quantity of instances in execution. Refer to the following Table 2:

TABLE 2

| Variable | Description |
|---|---|
| In_queue_count | This variable indicates a quantity of members |
| (quantity of instances in | of an App (function block) instance queue of |
| queue) | the current execution instance. |
| Running_app_count | This variable indicates a quantity of App |
| (quantity of instances in | instances that are being executed by the current |
| execution) | execution instance. |

In some embodiments, while creating an execution instance, the computer device may first initialize a quantity of instances in queue as a first default parameter, and initialize a quantity of instances in execution as a second default parameter. The first default parameter and the second default parameter may be the same or may be different. Generally, both the first default parameter and the second default parameter may be set to 0. The computer device performs, according to an execution status of a function block instance associated with the execution instance, accumulative processing or decrementing processing on the quantity of instances in queue, and performs accumulative processing or decrementing processing on the quantity of instances in execution; and if the computer device detects that the quantity of instances in queue is equal to the first default parameter, and the quantity of instances in execution is equal to the second default parameter, the computer device determines that the execution data of the execution instance is detected to meet the execution end condition.

For example, referring to FIG. 6 again, when execution of the node c and the node d is completed, because the node e to which the node c and the node d point is the loop end function code block, when the computer device obtains the loop end function code block, the computer device only creates the loop end function block instance corresponding to the loop end function code block for the first time, and does not create the loop end function block instance corresponding to the loop end function code block when obtaining the loop end function code block. In addition, the created loop end function block instance is not pushed to the function block instance queue, but pushed to the loop end function block instance queue for temporary storage. Therefore, when execution of the node c and the node d is completed, the quantity of instances in queue is decremented to 0, and the quantity of instances in execution is decremented to 0. Therefore, when it is detected that the execution data of the execution instance meets the execution end condition, it may be determined that execution of this round of iteration is completed.

It is assumed that the function block instance associated with the execution instance includes the target function block instance. A feasible implementation process of performing, according to an execution status of a function block instance associated with the execution instance, accumulative processing or decrementing processing on the quantity of instances in queue, and performing accumulative processing or decrementing processing on the quantity of instances in execution may be as follows: performing default accumulative processing on the queue instance data when the target function block instance is pushed to the function block instance queue; and performing default accumulative processing on the quantity of instances in execution when the target function block instance in the function block instance queue is executed, and performing default decrementing processing on the quantity of instances in queue. Then, when execution of the target function block instance is completed, the computer device may determine a creation status of a new target function block instance; perform default decrementing processing on the quantity of instances in execution if the new target function block instance is successfully created, and a function code block corresponding to the new target function block instance is the loop end function code block; perform, if the new target function block instance is successfully created and the function code block corresponding to the new target function block instance is not the loop end function code block, after the new target function block instance is pushed to the function block instance queue, accumulative processing on the quantity of instances in queue according to a quantity of the new target function block instance, and perform default decrementing processing on the quantity of instances in execution; and perform default decrementing processing on the quantity of instances in execution if creation of the new target function block instance fails.

The new target function block instance refers to a function block instance corresponding to a function code block to which a target function code block corresponding to the target function block instance points. Default accumulative processing refers to performing one-adding processing on the target data. For example, default accumulative processing is performed on the quantity of instances in queue, that is, adding one to the quantity of instances in queue to obtain a new quantity of instances in queue. Performing default accumulative processing on the quantity of instances in execution refers to adding one to the quantity of instances in execution to obtain a new quantity of instances in execution. Similarly, default decrementing processing refers to performing one-decrementing processing on the target data. Performing accumulative processing on the quantity of instances in queue according to the new quantity of target function block instances refers to adding the quantity of instances in queue to the new quantity of target function block instances to obtain a new quantity of instances in queue.

Accordingly, the quantity of instances in execution and the quantity of instances in queue are initially initialized to 0, and then, after the computer device starts the execution instance, the quantity of instances in execution and the quantity of instances in queue are accumulated or decremented according to an execution status of the target function block instance. As long as a new target function block instance is created and the new target function block instance is not the loop end function block instance when execution of the target function block instance is completed, the computer device performs accumulative processing on the quantity of instances in queue according to the new target function block instance, and the quantity of instances in execution and the quantity of instances in queue are not decremented to 0 at the same time. In this case, the execution data of the execution instance does not meet the execution end condition. Only when execution of the target function block instance is completed, and the computer device does not create a new target function block instance or a new target function block instance created by the computer device is the loop end function block instance, the computer device only performs default decrementing processing on the quantity of instances in execution. In this case, if the quantity of instances in queue is 0, the quantity of instances in execution is also decremented to 0, and the execution data of the execution instance meets the execution end condition. Therefore, when the computer device performs k rounds of iteration on the loop function code block, although the loop function code block may include multiple branches, because the function code block to which the end node of each branch points is a loop end function code block, after execution of the end nodes of all branches is completed, the quantity of instances in queue and the quantity of instances in execution are decremented to 0. Therefore, the computer device may determine, according to whether the execution data meets the execution end condition, whether the kth round of iteration on the loop function code block is completed.

In some embodiments, when the computer device determines that the Nth round of iteration on the loop function code block is completed, loop execution of the loop function code block by the computer device ends, but execution of at least two function code blocks has not ended. The computer device needs to push the loop end function block instance in the loop end function block instance queue to the function block instance queue, and continues to detect new execution data of the execution instance; and determines, if the new execution data meets the execution end condition, and the loop end function block instance queue is an empty queue, that execution of the at least two function code blocks is completed.

After the loop end function block instance is pushed to the function block instance queue, as the computer device extracts and executes the loop end function block instance from the function block instance queue, the function code block that is in the at least two function code blocks and that is located after the loop end function code block is executed sequentially according to the pointing relationship, and in a process in which the function code block that is in the at least two function code blocks and that is located after the loop end function code block is executed sequentially, the computer device also continues to perform accumulative processing or decrementing processing on the execution data. When the computer device detects again that the new execution data meets the execution end condition, there are two possibilities: One is that a new loop function code block appears, and loop execution of the new loop function code block is the same as loop execution of the foregoing loop function code block. Details are not described herein again. The second is that all function code blocks that are in the at least two function code blocks that are located after the loop end function code block are executed, no new function block instance is established, and new execution data also meets the execution end condition. For the two cases, in the first case, the loop end function block instance queue necessarily temporarily stores a new loop end function block instance. Therefore, the computer may determine, as long as it is determined that the loop end function block instance queue is an empty queue, that the function code blocks that are in the at least two function code blocks and that are located after the loop end function code block are executed, and that the function code blocks that are in the at least two function code blocks and that are located before the loop end function code block are executed. Therefore, the computer device may determine that the at least two function code blocks are executed.

According to the method provided in this embodiment of this application, when an object creates a workflow by using a workflow engine, for a function code block that wants to be executed for multiple times, the object only needs to place the function code block between a loop start function code block and a loop end function code block. The object does not need to have other programming experience, which reduces a threshold for using the workflow engine, and improves ease of use and functionality of the workflow engine.

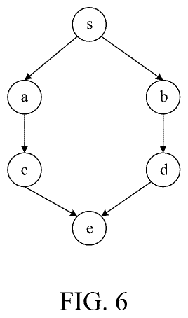

Further, referring to FIG. 7, FIG. 7 is a schematic flowchart of a data processing method according to an embodiment of this application. The method may be performed by a computer device. The computer device may be the service server 100 shown in FIG. 1, or may be any terminal device, such as the terminal device 10c, in the terminal device cluster shown in FIG. 1. The following uses an example in which the method is performed by a computer device for description. The data processing method may include at least the following operations S201 to S205:

Operation S201: Receive a trigger request for a target workflow, and create an execution instance corresponding to the target workflow.

Specifically, for the execution process of operation S201, refer to the foregoing description of operation S101. Details are not described herein again.

Operation S202: Create an execution instance table corresponding to the execution instance while the execution instance corresponding to the target workflow is created; the execution instance table being configured for recording an execution status of the execution instance.

Specifically, the execution instance may be represented as execution, and the execution instance table is an execution table. The execution table is configured for recording information such as a process relationship and execution time of the target workflow. A table structure of the execution table is shown in the following Table 3:

TABLE 3

| executionId | workflow_id | name | executor | status | start_at | end_at | apps |
|---|---|---|---|---|---|---|---|
| Execution | Workflow | Name | Executor | Status | Start | End | Pointing |
| instance identifier | identifier | | | | time | time | relationship |

The apps field is relatively important and records a process structure of the target workflow, where the process structure includes a pointing relationship between at least two function code blocks corresponding to the target workflow. The computer device traverses and executes the at least two function code blocks according to the pointing relationship included in the process structure of the target workflow.

For a process data structure of the target workflow stored in the apps recorded in Table 3, references may be made to the following Table 4:

TABLE 4

| StartAppInstId | DestAppInstId | Apps |
|---|---|---|
| From which App | To which | Name: App instance description |
| instance | App instance | Parameters: <parameter key, |
| | | parameter value, |
| | | parameter type, parameter description> |
| | | Template: App template |
| | | used by an App instance |
| | | Position: Coordinate position |
| | | of an App instance |
| | | in a front canvas |
| | | InstId: represents a unique |
| | | Id (identifier) of an |
| | | App instance in a workflow |
| | | PrevAppInstIds: Previous |
| | | App instance Id pointed |
| | | to |
| | | NextAppInstIds: Next App |
| | | instance Id pointed to |
| | | Output: Output result |
| | | of an App instance |
| | | Error: If an error occurs |
| | | in execution of an App |
| | | instance, an error message |
| | | is displayed here |
| | | Status:Status of an App instance |
| | | StartTime: Start time |
| | | of execution of an App |
| | | instance |
| | | EndTime: End time |
| | | of execution of an App |
| | | instance |

Each App has a unique InstId, and the computer device may identify the App in the process by using InstId. After creating the execution table, the computer device stores it into a database. In addition, the computer device pushes the execution instance id to an execution message queue, which then waits for consumption and execution by a distributed workflow engine cluster.

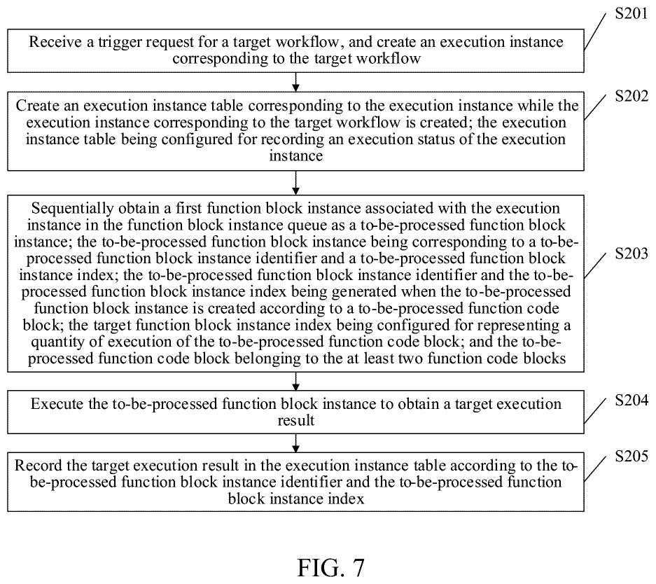

For ease of understanding, referring to FIG. 8, FIG. 8 is a schematic diagram of an execution instance message queue according to an embodiment of this application. As shown in FIG. 8, for a newly generated execution instance 81, the computer device first pushes it to an execution instance message queue 800, and the execution instance 81 is located at the tail of the execution instance message queue 800. The computer device may consume, by using a workflow engine cluster 801, an execution instance in the execution instance message queue 800, where the workflow engine cluster 801 may include multiple containers, and the containers are independent of each other, that is, processes in which different containers execute different execution instances will not affect each other. Whenever the computer device detects that the workflow engine cluster meets an instance execution condition, the computer device obtains an execution instance from the head of the execution instance message queue, and then transfers the execution instance to a target container for execution. That the workflow engine cluster meets the instance execution condition may mean that the workflow engine cluster has an idle container. For example, as shown in FIG. 8, assuming that the computer device detects that a container1 is idle, the computer device obtains an execution instance 82 from the head of the execution instance message queue 800, and then transfers the execution instance 82 to the container 1 for execution.

Operation S203: Sequentially obtain a first function block instance associated with the execution instance in the function block instance queue as a to-be-processed function block instance; the to-be-processed function block instance being corresponding to a to-be-processed function block instance identifier and a to-be-processed function block instance index; the to-be-processed function block instance identifier and the to-be-processed function block instance index being generated when the to-be-processed function block instance is created according to a to-be-processed function code block; the target function block instance index being configured for representing a quantity of execution of the to-be-processed function code block; and the to-be-processed function code block belonging to the at least two function code blocks.

Specifically, after obtaining the execution instance corresponding to the target workflow by using the workflow execution engine cluster, the computer device initializes a status of each function code block in the execution instance as to-be-processed, obtains a start node in the target workflow, that is, a trigger App (trigger function code block) according to the pointing relationship, creates a trigger App instance, and pushes the trigger App instance to an App instance queue (that is, the function block instance queue) for execution. In a subsequent execution process of the execution instance, an App instance corresponding to each App created by the computer device is pushed to the App instance queue.

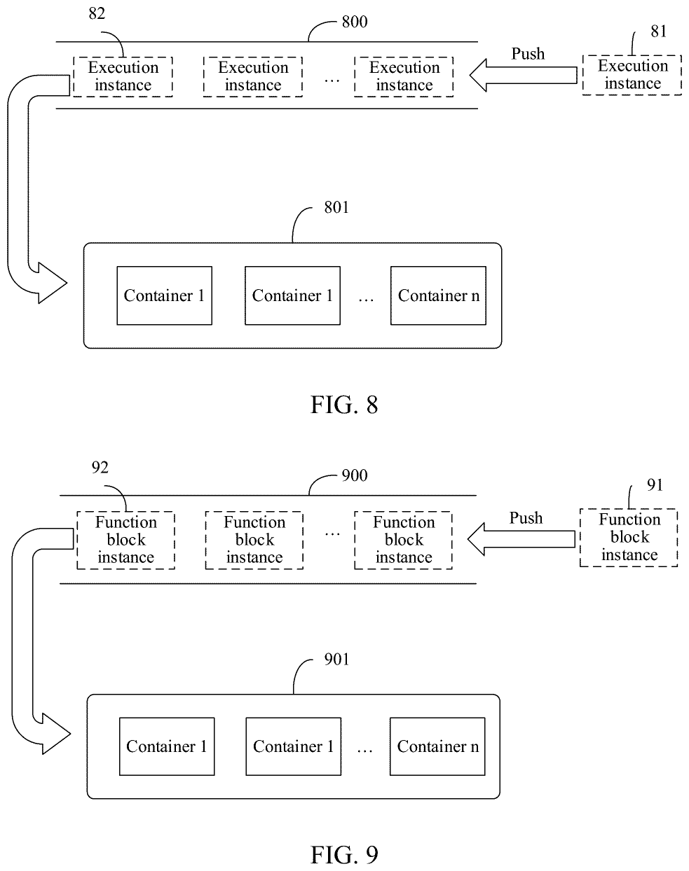

For ease of understanding, referring to FIG. 9, FIG. 9 is a schematic diagram of a function block instance queue according to an embodiment of this application. As shown in FIG. 9, an App instance queue 900 is similar to the foregoing execution message queue 800 in structure, and a newly created App instance, such as an App instance 91, is pushed to the tail of the App instance queue 900. When the computer device consumes the App instance by using a workflow engine cluster 901, the computer device obtains an App instance at the head of the App instance queue, that is, an App instance 92. In addition, an element format of the App instance queue may be: appInst #executionId #appInstId #index, that is, app instance/execution record id/app instance id/index. Based on the element format, after the computer device consumes the App instance, a specific execution instance and execution data of a certain App at certain time may be located.

In the foregoing data structure shown in Table 4, the App instance has a Parameters array (input parameter), and a structure thereof is <parameter key, parameter value, parameter type, parameter description>. The parameter type is: string, boolean, number, etc. The value in the parameter can use either a constant (a number or a string) or a path syntax expression to reference an output result of any previous app instance.

Operation S204: Execute the to-be-processed function block instance to obtain a target execution result.

Specifically, the to-be-processed function block instance may include a requirement data obtaining path, and a feasible implementation process in which the computer device executes the to-be-processed function block instance to obtain the target execution result may be as follows: querying an idle status of a computing resource of an execution engine container, and identifying an execution engine container with a largest idle computing resource as a target execution engine container; and transferring the to-be-processed function block instance from the function block instance queue to the target execution engine container, obtaining requirement data from the target execution engine container according to the requirement data obtaining path, and executing the to-be-processed function block instance according to the requirement data to obtain the target execution result.

The requirement data obtaining path is a path syntax expression used in the Parameters array corresponding to the App instance. Because runtime data of each App instance is stored in a database (DB), after creating an execution instance, the computer device first loads all App instance execution data under a current execution instance into a memory to form a mapping map global variable structure of an App instance ID.

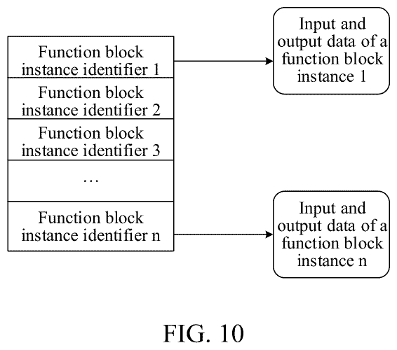

For ease of understanding, referring to FIG. 10, FIG. 10 is a schematic diagram of a global variable data structure of a memory during execution of a workflow according to an embodiment of this application. By using the structure shown in FIG. 10, the computer device may perform positioning by using a function block instance id of the App instance, and globally obtain input and output data of any App instance in the workflow, so as to parse the path syntax expression used in the App instance parameter into corresponding data.

Operation S205: Record the target execution result in the execution instance table according to the to-be-processed function block instance identifier and the to-be-processed function block instance index.

Specifically, because one App in the process may be executed for multiple times, the App corresponds to multiple execution results. When the computer device records, in the execution instance table by using the to-be-processed function block instance identifier, the to-be-processed function code block corresponding to the target execution result, the computer device further needs to record, by using the to-be-processed function block instance index, that the target execution result is which execution result corresponding to the to-be-processed function code block.

In some embodiments, when obtaining the to-be-processed function block instance, the computer device updates the status in the function block instance table corresponding to the function block instance to “processing”, and sets start execution time. The function block instance table may be represented as an App instance table, and is configured for recording an execution status of a function code block. For an available structure of the function block instance table, refer to the following Table 5:

TABLE 5

| Field | Description |
|---|---|
| id | Auto-increment primary key ID |
| index | Index location of a current App |
| | execution result. If it is in a For loop body, |
| | the App may be executed for multiple |
| | times, and the Index is incremented |
| | from 0. Otherwise, the default value |
| | of Index is 0, indicating that it has |
| | been executed once. |
| execution_id | Execution ID |
| app_inst_id | App instance ID. Each node App in |
| | a flowchart is assigned a generated |
| | unique App instance ID for |
| | positioning and identification. |
| name | App instance name |
| template | Template type used by an App (such |
| | as an HTTP request and a python |
| | script). Different App templates |
| | support different functions. |
| status | Status. Four states are included: |
| | to-be-processed, processing, completed, |
| | and error. |
| start_at | Execution start time |
| end_at | Execution end time |
| apps | Parameter and runtime data of an App instance |

In some embodiments, because an App in a process may be executed for multiple times, multiple pieces of data may be created in an App instance table corresponding to the App. For example, multiple execution results of an App instance may be represented as: [{app_inst_id=x, index=0}, {app_inst_id=x, index=1}, . . . , {app_inst_id=x, index=n}]. A certain execution result of the App can be uniquely acknowledged by using app_inst_id and index fields.

The apps field in Table 5 stores data of a JSON structure, and is configured for recording an execution result of a current App instance at a certain time, a front and rear App, an input parameter, and runtime data information. For an available format of the Apps field, refer to the following Table 6:

TABLE 6

| Index | MaxIndexCount | Name | Parameters | Template |
|---|---|---|---|---|
| 0 | 1 | App instance | <parameter key, | App template |
| | | description | parameter value, | used by an App |
| | | | parameter type, | instance |
| | | | parameter | |
| | | | description> | |
| Position | InstId | Prev AppInstIds | NextAppInstIds | Output |
| Coordinate | Unique Id for | Previous App | Next App instance | Output result |
| position of an | representing an | instance Id | Id pointed to | of an App |
| App instance in | App instance in a | pointed to | | instance |
| a front canvas | workflow | | | |
| Error | Status | StartTime | EndTime | |
| Error | Status of an App | Start time of | End time of | |
| information if | instance | execution of an | execution of an | |
| an error occurs | | App instance | App instance | |
| during | | | | |
| execution of an | | | | |
| App instance | | | | |

For descriptions of the App instance members Index and MaxIndexCount in the apps, refer to the following Table 7:

TABLE 7

| | |
|---|---|
| Index | Index location of a current App |
| | execution record, starting from 0. If |
| | a For loop is used, the Index |
| | of the App in the loop body is |
| | incremented from 0. |
| MaxIndexCount | Record a quantity of times a |
| (maximum quantity of | current App is executed. |
| execution) | If it is in a For loop body, it is |
| | greater than or equal to 1, that is, |
| | each App may be executed for |
| | multiple times. If it is not in a For |
| | loop body, the default value is 1, |
| | that is, each App is executed once. |

When an execution result of an App in an execution instance needs to be obtained, because the App may be executed for multiple times in the For loop body, a quantity of execution times of the App first needs to be obtained, that is, MaxIndexCount, and then all execution results of the App are successively obtained according to InstId and Index of the App.

In some embodiments, when the to-be-processed function block instance corresponding to the to-be-processed function code block is created, an identifier configured for uniquely identifying the to-be-processed function code block is obtained as the to-be-processed function block instance identifier corresponding to the to-be-processed function block instance; if the to-be-processed function block instance identifier is not found in the execution instance table, it is determined that the to-be-processed function block instance index is a default index; and if the to-be-processed function block instance identifier is found in the execution instance table, a history index whose record time is the latest and associated with the to-be-processed function block instance identifier is obtained, and accumulative processing is performed on the history index to obtain the to-be-processed function block instance index.

In short, the computer device may obtain a history index of the to-be-processed function code block executed last time, and increments the history index by one to obtain the to-be-processed function block instance identifier corresponding to the to-be-processed function block instance. However, if the to-be-processed function code block is not previously executed, the to-be-processed function block instance identifier is set to a default index, that is, 0.

In some embodiments, when creating the to-be-processed function block instance, the computer device further needs to update MaxIndexCount in a to-be-processed function block instance table corresponding to the to-be-processed function code block. Similarly, the computer device may directly obtain MaxIndexCount in the to-be-processed function block instance table when the to-be-processed function code block is executed last time, and then increment MaxIndexCount by one to obtain MaxIndexCount corresponding to current execution, and then write MaxIndexCount corresponding to the current execution into the to-be-processed function block instance table.

In some embodiments, for different workflow structures, index and MaxIndexCount may also be determined in different parameter adjustment modes. Assuming that the computer device completes execution of a current App, the computer device needs to create a nextAppInst (a next App instance) corresponding to a nextApp (a next App) to which the current App points. First, the computer device may obtain InstId corresponding to nextApp, query, by using InstId, an App instance table corresponding to nextApp, and obtain data (including a template type, a parameter, and a location) of nextAppInst from the App instance table. Then, the computer device constructs instance data corresponding to nextAppInst. Further, the computer device may obtain an Index value at the latest execution of nextApp according to executionId and appInstId corresponding to nextApp: lastIndex, and initialize the variable idx=lastIndex+1. If nextApp is executed for the first time, there is no execution record in the App instance table corresponding to nextApp. By default, lastIndex is −1. Then, the computer device may determine, according to a logical structure between the current App and nextApp, the index and MaxIndexCount corresponding to nextAppInst.

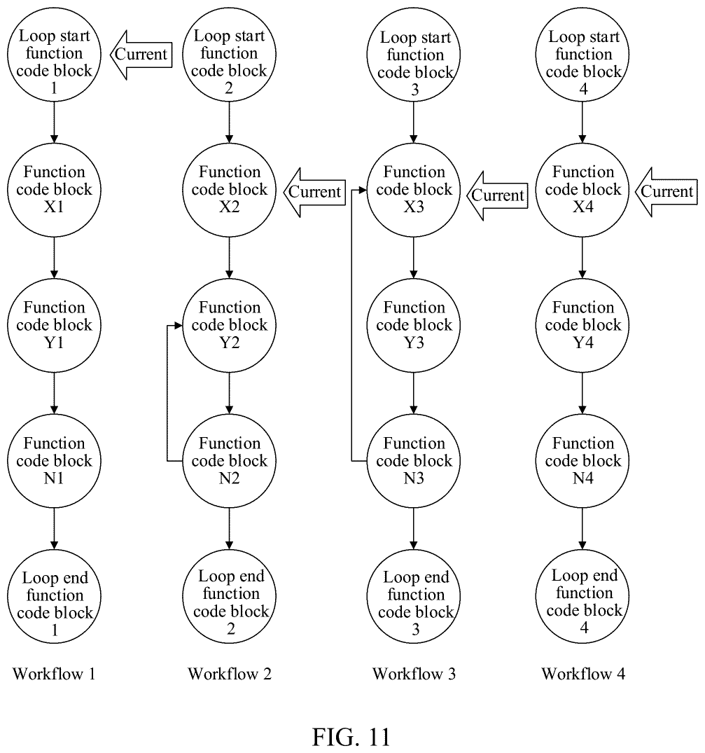

To facilitate understanding of a process in which the computer device determines an index corresponding to nextAppInst based on a current App, refer to FIG. 11. FIG. 11 is a schematic diagram of an index determining scenario according to an embodiment of this application. That the computer device determines the index corresponding to nextAppInst is mainly divided into four cases: (1) As shown in a workflow 1 shown in FIG. 11, a current App is a loop start function code block 1 (that is, a For loop start App). In this case, nextApp to which the current App points is a function code block X1, and the computer device determines nextAppInst.Index=idx. (2) As shown in a workflow 2 shown in FIG. 11, it is assumed that a current App is a function code block X2, and nextApp to which the current App points is a function code block Y2. In this case, the current App is not a For loop start App, and the current App is not in the loop, but nextApp is in the loop. Then, the computer device may determine nextAppInst.Index=idx. The loop means that a loop may be formed when a pointing relationship between function code blocks meets a condition, and a function code block Y2 and a function code block N2 in the workflow 2 form a loop. (3) As shown in a workflow 3 shown in FIG. 11, it is assumed that a current App is a function code block X3, and nextApp to which the current App points is a function code block Y3. In this case, the current App is not a For loop start App, and the current App is in the loop. Then, the computer device may determine nextAppInst.Index=idx. (4) As shown in a workflow 4 shown in FIG. 11, it is assumed that a current App is a function code block X4, and nextApp to which the current App points is a function code block Y4. In this case, the current App is not a For loop start App, and the current App is not in the loop and nextApp is not in the loop. Then, the computer device may determine nextAppInst.Index=todoApp.Index, where todoApp.Index refers to an index of the current App.

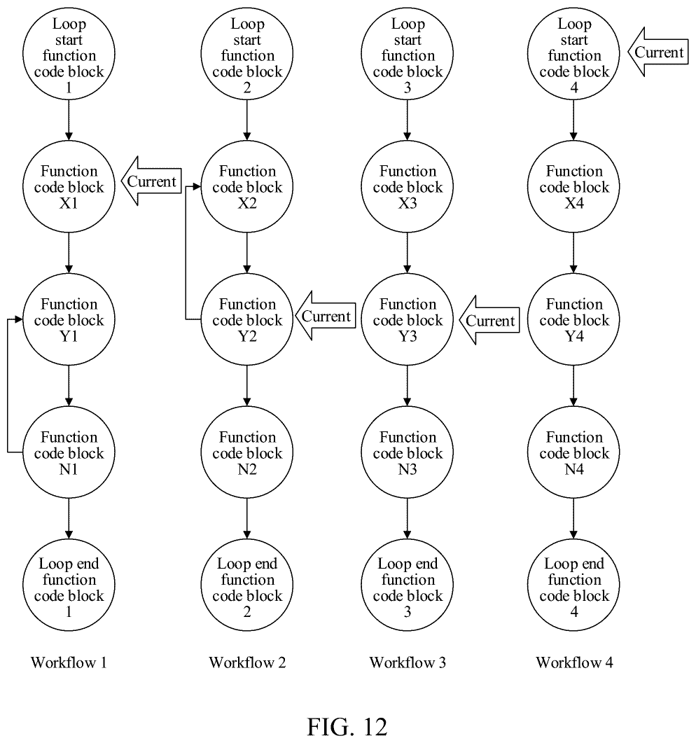

To facilitate understanding of a process in which the computer device determines MaxIndexCount corresponding to nextAppInst based on a current App, refer to FIG. 12. FIG. 12 is a schematic diagram of an index determining scenario according to an embodiment of this application. That the computer device determines the MaxIndexCount corresponding to nextAppInst is mainly divided into four cases: (1) In a workflow 1 shown in FIG. 12, a current App is a function code block X1, and in this case, nextApp to which the current App points is a function code block Y1. In this case, the current App is not in a loop, but nextApp is in the loop. Then, the computer device determines nextAppInst. MaxIndexCount=idx+1. (2) In a workflow 2 shown in FIG. 12, a current App is a function code block Y2, and in this case, nextApp to which the current App points is a function code block N2. In this case, the current App is in a loop, but nextApp is not in the loop. Then, the computer device determines nextAppInst. MaxIndexCount=idx+1. (3) In a workflow 3 shown in FIG. 12, a current App is a function code block Y3, and in this case, nextApp to which the current App points is a function code block N3. In this case, the current App is not in a loop and nextApp is not in the loop. Then, the computer device determines nextAppInst. MaxIndexCount=todoApp. MaxIndexCount, where todoApp. MaxIndexCount refers to MaxIndexCount of the current App. (4) In a workflow 4 shown in FIG. 12, a current App is a loop start function code block 4. In this case, nextApp to which the current App points is a function code block X4. In this case, the computer device determines nextAppInst. MaxIndexCount=a maximum quantity of loops, where the maximum quantity of loops is the loop parameter in the foregoing.

In the foregoing process of determining the index and MaxIndexCoun corresponding to nextAppInst, if nextAppInst is a loop end function block instance, the computer device needs to reset the Index thereof to 0 and MaxIndexCount to 1.

In the foregoing mode of determining the index and MaxIndexCount corresponding to nextAppInst based on the current App, it is easier to assemble data in subsequent execution results of the App, because in a case of no loop, the index and MaxIndexCount inherit upward, that is, the index and MaxIndexCount corresponding to execution results corresponding to Apps executed in the same round are the same.

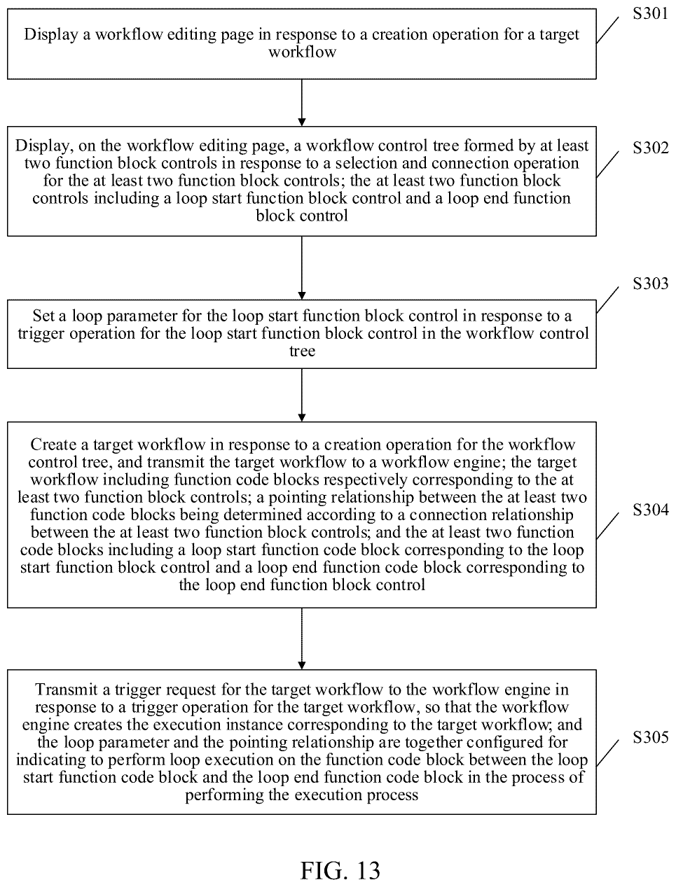

Further, referring to FIG. 13, FIG. 13 is a schematic flowchart of a data processing method according to an embodiment of this application. The method may be performed by a computer device. The computer device may be the service server 100 shown in FIG. 1, or may be any terminal device, such as the terminal device 10c, in the terminal device cluster shown in FIG. 1. The following uses an example in which the method is performed by a computer device for description. The data processing method may include at least the following operations S301 to S305:

Operation S301: Display a workflow editing page in response to a creation operation for a target workflow.

Operation S302: Display, on the workflow editing page, a workflow control tree formed by at least two function block controls in response to a selection and connection operation for the at least two function block controls; the at least two function block controls including a loop start function block control and a loop end function block control.

Operation S303: Set a loop parameter for the loop start function block control in response to a trigger operation for the loop start function block control in the workflow control tree.

In specific implementation, the computer device may display a loop editing text box in response to a trigger operation for the loop start function block control in the workflow control tree, and set a loop parameter for the loop start function block control in response to an input operation for the loop editing text box.

Operation S304: Create a target workflow in response to a creation operation for the workflow control tree, and transmit the target workflow to a workflow engine; the target workflow including function code blocks respectively corresponding to the at least two function block controls; a pointing relationship between the at least two function code blocks being determined according to a connection relationship between the at least two function block controls; and the at least two function code blocks including a loop start function code block corresponding to the loop start function block control and a loop end function code block corresponding to the loop end function block control.

Operation S305: Transmit a trigger request for the target workflow to the workflow engine in response to a trigger operation for the target workflow.

The trigger request for the target workflow is transmitted to the workflow engine, so that the workflow engine can create the execution instance corresponding to the target workflow; and further, indicate the loop function code block between the loop start function code block and the loop end function code block to perform loop execution according to the loop parameter indicated by the loop start function code block in the execution instance and the pointing relationship in the execution instance.

Specifically, for an implementation process of operation S301 to operation S305, refer to the schematic diagram of the scenario shown in FIG. 2a. Details are not described herein again in this application.

According to the method provided in this embodiment of this application, when an object creates a workflow by using a workflow engine, for a function code block that wants to be executed for multiple times, the object only needs to place the function code block between a loop start function code block and a loop end function code block. The object does not need to have other programming experience, which reduces a threshold for using the workflow engine, and improves ease of use and functionality of the workflow engine.

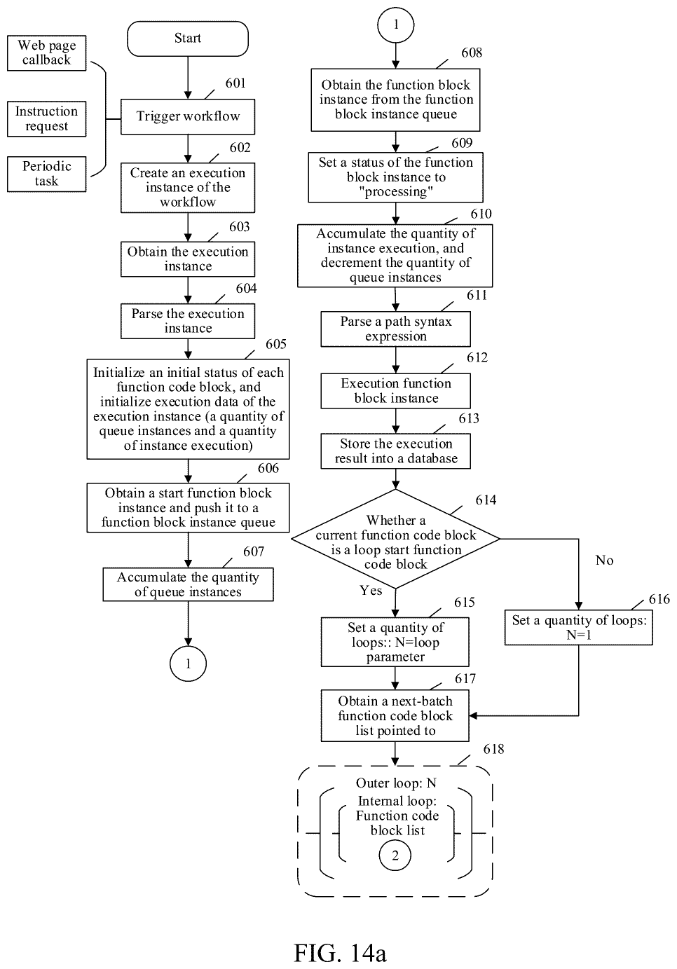

Further, referring to FIG. 14a and FIG. 14b, FIG. 14a and FIG. 14b are overall schematic flowcharts of supporting implementation of loop workflow execution according to an embodiment of this application. It may be learned from FIG. 14a and FIG. 14b that the overall process may be executed by a computer device, and mainly includes the following operations:

Operation S601: Trigger a workflow.

Specifically, there are many modes of triggering a workflow, for example, web page callback, that is, the foregoing webhook call; an instruction request, that is, the foregoing instruction trigger; and a periodic task, that is, the foregoing Cron trigger. The computer device may determine triggering of the workflow according to different trigger requests. For a specific implementation process, refer to the description of operation S101 in the embodiment corresponding to FIG. 3. Details are not described herein again.

Operation S602: Create an execution instance of the workflow.

Specifically, the computer device creates the execution instance and an execution instance table. After creation is completed, the computer device pushes the execution instance to an execution instance message queue for execution, as shown in FIG. 8.

Operation S603: Obtain the execution instance.

Specifically, the computer device obtains the execution instance from the execution instance message queue in sequence.

Operation S604: Parse the execution instance.

Specifically, after obtaining the execution instance from the execution instance message queue, the computer device first parses the execution instance.

Specifically, for implementation of operation S602 to operation S604, refer to operation S202 in the embodiment corresponding to FIG. 7. Details are not described herein again.

Operation S605: Initialize an initial status of each function code block, and initialize execution data of the execution instance (a quantity of instances in queue and a quantity of instances in execution).

Specifically, after parsing the execution instance, the computer device changes an initial status of each function code block in the execution instance table to a to-be-processed state, and then initializes the quantity of instances in queue=0, and initializes the quantity of instances in execution=0.

Operation S606: Obtain a start function block instance and push it to a function block instance queue.

Operation S607: Accumulate the quantity of instances in queue.

Specifically, the computer device increments the quantity of instances in queue by 1.

Operation S608: Obtain the function block instance from the function block instance queue.

Operation S609: Set a status of the function block instance to “processing”.

Operation S610: Accumulate the quantity of instances in execution, and decrement the quantity of instances in queue.

Specifically, the computer device increments the quantity of instances in execution by 1 and the quantity of instances in queue by 1.

Specifically, for an implementation process of operation S605 to operation S610, refer to the foregoing process of performing, according to an execution status of a function block instance associated with the execution instance, accumulative processing or decrementing processing on the quantity of instances in queue, and performing accumulative processing or decrementing processing on the quantity of instances in execution in operation S104. Details are not described herein again.

Operation S611: Parse a path syntax expression in the function block instance to obtain to-be-executed data.

Specifically, the computer device may obtain, according to the path syntax expression corresponding to the function block instance, data required when the function block instance is executed.

Operation S612: Execute the function block instance according to the to-be-executed data to obtain an execution result.

Operation S613: Store the execution result into a database.

Specifically, the computer device may write the execution result into the database according to an index and a function block instance identifier corresponding to the function block instance.

Specifically, for operation S611 to operation S613, refer to descriptions of operation S203 and operation S204 in the foregoing embodiment corresponding to FIG. 7. Details are not described herein again.

Operation S614: Determine whether a current function code block is a loop start function code block.

Specifically, the current function code block is a function code block corresponding to a function block instance that has just been executed. If yes, operation S615 is performed. If no, operation S616 is performed.

Operation S615: Set a quantity of loops: N=loop parameter.

Operation S616: Set a quantity of loops: N=1.

Operation S617: Obtain a next-batch function code block list to which the current function code block points.

Operation S618: Perform N times of loops according to the quantity of loops.

Specifically, a process of one loop starts from operation S619 corresponding to node \textcircled{2} until operation S629, and it may be determined whether one loop ends.

Operation S619: Create the next function block instance.

Specifically, the computer device performs an internal loop according to a next-batch function code block list to establish function block instances respectively corresponding to function code blocks included in the next-batch function code block list.

Operation S620: Determine an index and a maximum quantity of loops corresponding to the next function block instance.

Specifically, the index is the foregoing index; and the maximum quantity of loops is MaxIndexCount.

Specifically, for a determining mode, refer to the foregoing parameter adjustment modes shown in FIG. 11 and FIG. 12.

Operation S621: Determine whether the next function code block is a loop end function code block.

Specifically, the computer device may also first determine whether the next function code block is a loop end function code block, and then determine whether to create a function block instance corresponding to the next function code block, which is not limited in this application. If the next function code block is a loop end function code block, operation S622 is performed; otherwise, operation S627 is performed.

Operation S622: Reset the index=0, and the maximum quantity of loops=1.

Operation S623: Determine whether the next function code block is created for the first time.

Specifically, in this case, the next function code block is a loop end function code block. Therefore, the next function code block only needs to be created once. If the computer device determines that the next function code block is created for the first time, operation S624 is performed. Otherwise, operation S625 is performed.

Operation S624: Push the next function block instance to a loop end function block instance queue, and perform operation S626.

Operation S625: Discard the next function block instance, and perform operation S626.

Operation S626: Decrement the quantity of execution instances, and perform operation S629.

Specifically, the quantity of instances in execution is decremented by 1.

Operation S627: Push the next function block instance to a function block instance queue.

Operation S628: Accumulate the quantity of instances in queue, and decrease the quantity of instances in execution.

Specifically, the quantity of instances in queue is incremented by 1; and the quantity of instances in execution is decremented by 1.

Operation S629: Determine whether the execution data meets an execution end condition.

Specifically, it is determined whether the quantity of instances in queue and the quantity of instances in execution are both 0. If no, the computer device is waited for performing operation S608 corresponding to node \textcircled{1}. If yes, the current loop ends, and operation S630 is performed.

Operation S630: Determine whether an outer loop ends.

Specifically, if the outer loop does not end, the quantity of loops does not reach N, and the computer device needs to start a next round of loop from operation S619 corresponding to node \textcircled{2}. In this case, the next function block instance created in operation S619 is determined according to the next-batch function block list to which the loop start function code block points. If the outer loop ends, operation S631 is performed.

Operation S631: Determine whether the loop end function block instance queue has a loop end function block instance.

Specifically, if yes, operation S632 is performed. If no, operation S634 is performed.

Operation S632: Accumulate the quantity of instances in queue.

Specifically, the quantity of instances in queue is incremented by 1.

Operation S633: Push the loop end function block instance to the function block instance queue, and wait for the computer device to perform operation S608 corresponding to node \textcircled{1}.

Operation S634: Clear a cache of the function block instance.

Specifically, the cache refers to data temporarily stored in a running process of the execution instance.

Operation S635: Update an execution instance status and update the database.

Specifically, for an implementation process of operation S614 to operation S635, refer to the description of operation S104 in the foregoing embodiment corresponding to FIG. 3 and the description of operation S205 in the foregoing embodiment corresponding to FIG. 4. Details are not described herein again.

According to the method provided in this embodiment of this application, a For loop traversal function is implemented in a process engine visualization mode based on an App fine-granularity execution mechanism and with reference to a For loop index adjustment algorithm, so that some scenarios in which arrays or lists are executed in a traversal mode are implemented. The system designed and implemented based on this solution supports use of a visual low-code mode to implement For loop traversal, which greatly lowers a use threshold of the system and eliminates a need for an object to master special programming experience, thereby greatly improving efficiency.

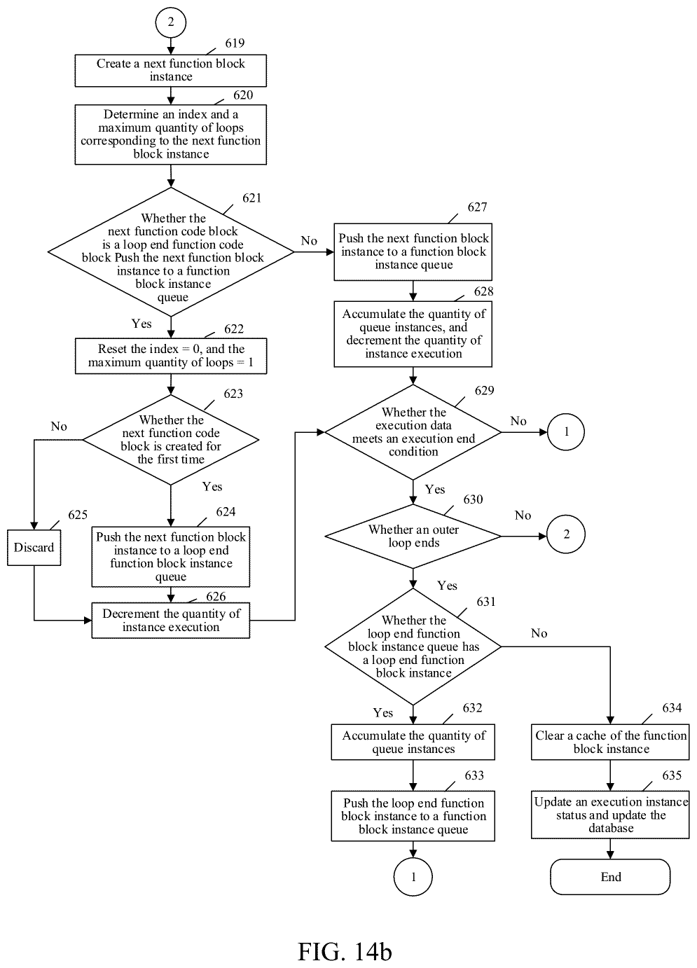

Referring to FIG. 15, FIG. 15 is a schematic structural diagram of a data processing apparatus according to an embodiment of this application. The data processing apparatus may be a computer program (including program code) running in a computer device. For example, the data processing apparatus is application software. The apparatus may be configured to perform corresponding operations in the data processing method provided in the embodiment of this application. As shown in FIG. 15, the data processing apparatus 1 may include: a trigger module 101, a loop start module 102, a loop confirmation module 103, and a loop execution module 104.

The trigger module 101 is configured to create an execution instance corresponding to a target workflow; the execution instance including a pointing relationship between at least two function code blocks included in the target workflow; and the at least two function code blocks including a loop start function code block and a loop end function code block;
the loop start module 102 is configured to obtain a loop parameter corresponding to the loop start function code block;
the loop confirmation module 103 is configured to determine, according to the pointing relationship, a function code block between the loop start function code block and the loop end function code block as a loop function code block; and
the loop execution module 104 is configured to cyclically execute the loop function code block according to the loop parameter and the pointing relationship.

For specific implementations of the trigger module 101, the loop start module 102, the loop confirmation module 103, and the loop execution module 104, refer to specific descriptions of operation S101 to operation S104 in the foregoing embodiment corresponding to FIG. 3. Details are not described herein again.

The loop start module 102 is specifically configured to:
create a loop start function block instance corresponding to the loop start function code block, push the loop start function block instance to a function block instance queue, and when execution of the loop start function block instance in the function block instance queue succeeds, obtain the loop parameter corresponding to the loop start function code block; and
the loop execution module 104 is specifically configured to:
cyclically execute the loop function code block according to the loop parameter, the function block instance queue, and the pointing relationship.

The loop parameter is N, and N is a positive integer greater than or equal to 1.

The loop execution module 104 includes: a first iteration unit 1041 and a second iteration unit 1042.

The first iteration unit 1041 is configured to: determine, according to the pointing relationship in a kth round of iteration on the loop function code block, a list of to-be-executed function code blocks to which the loop start function code block points; k being a positive integer less than or equal to N.

The first iteration unit 1041 is further configured to: determine, according to the pointing relationship if the list of to-be-executed function code blocks does not include the loop end function code block, and a target to-be-executed function block instance corresponding to a target to-be-executed function code block in the function block instance queue is executed successfully, a new list of to-be-executed function code blocks to which the target to-be-executed function code block points until it is determined that the kth round of iteration on the loop function code block is completed; the target to-be-executed function code block being a function code block in the list of to-be-executed function code blocks.

The second iteration unit 1042 is configured to: continue to perform a (k+1)th round of iteration on the loop function code block if k is less than N.

For specific implementations of the first iteration unit 1041 and the second iteration unit 1042, refer to specific descriptions of operation S104 in the embodiment corresponding to FIG. 3. Details are not described herein again.

The data processing apparatus 1 further includes: a third iteration module 105, a push module 106, and a first detection module 107.

The third iteration module 105 is configured to: query a loop end function block instance queue if the new list of to-be-executed function code blocks includes the loop end function code block; or if the loop end function block instance queue is an empty queue, push a loop end function block instance corresponding to the loop end function code block to the loop end function block instance queue;
the third iteration module 105 is further configured to: determine, if execution data of the execution instance meets an execution end condition, that the kth round of iteration on the loop function code block is completed;
the push module 106 is configured to: push, when it is determined that an Nth round of iteration on the loop function code block is completed, the loop end function block instance in the loop end function block instance queue to the function block instance queue to detect new execution data of the execution instance; and
the first detection module 107 is configured to: determine, if the new execution data meets the execution end condition, and the loop end function block instance queue is an empty queue, that execution of the at least two function code blocks is completed.

For specific implementations of the third iteration module 105, the push module 106, and the first detection module 107, refer to descriptions of operation S104 in the embodiment corresponding to FIG. 3. Details are not described herein again.

The execution data includes a quantity of instances in queue and a quantity of instances in execution.

The data processing apparatus 1 further includes: a data initialization module 108, a first data update module 109, and a second detection module 110.

The data initialization module 108 is configured to: initialize the quantity of instances in queue as a first default parameter while the execution instance is created, and initialize the quantity of instances in execution as a second default parameter;
the first data update module 109 is configured to perform, according to an execution status of a function block instance associated with the execution instance, accumulative processing or decrementing processing on the quantity of instances in queue, and perform accumulative processing or decrementing processing on the quantity of instances in execution; and
the second detection module 110 is configured to: determine, if the quantity of instances in queue is equal to the first default parameter, and the quantity of instances in execution is equal to the second default parameter, that the execution data of the execution instance is detected to meet the execution end condition.

For specific implementations of the data initialization module 108, the first data update module 109, and the second detection module 110, refer to descriptions of operation S104 in the embodiment corresponding to FIG. 3. Details are not described herein again.

The function block instance associated with the execution instance includes a target function block instance.

The first data update module 109 includes: a first update unit 1091 and a second update unit 1092.

The first update unit 1091 is configured to: perform accumulative processing on the queue instance data when the target function block instance is pushed to the function block instance queue; and
the second update unit 1092 is configured to: perform default accumulative processing on the quantity of instances in execution when the target function block instance in the function block instance queue is executed, and perform default decrementing processing on the quantity of instances in queue.

For specific implementations of the first update unit 1091 and the second update unit 1092, refer to specific descriptions of operation S104 in the embodiment corresponding to FIG. 3. Details are not described herein again.

The data processing apparatus further includes: a second data update module 111.

The second data update module 111 is configured to: determine a creation status of a new target function block instance when execution of the target function block instance is completed;
the second data update module 111 is further configured to: perform default decrementing processing on the quantity of instances in execution if the new target function block instance is successfully created, and a function code block corresponding to the new target function block instance is the loop end function code block;
the second data update module 111 is further configured to: perform, if the new target function block instance is successfully created and the function code block corresponding to the new target function block instance is not the loop end function code block, after the new target function block instance is pushed to the function block instance queue, accumulative processing on the quantity of instances in queue according to a quantity of the new target function block instance, and perform default decrementing processing on the quantity of instances in execution; and
the second data update module 111 is further configured to: perform default decrementing processing on the quantity of instances in execution if creation of the new target function block instance fails.

For a specific implementation of the second data update module 111, refer to specific descriptions of operation S104 in the embodiment corresponding to FIG. 3. Details are not described herein again.

The data processing apparatus 1 further includes: a table creation module 112, an instance obtaining module 113, an instance execution module 114, and a table recording module 115.

The table creation module 112 is configured to: create an execution instance table corresponding to the execution instance while the execution instance corresponding to the target workflow is created; the execution instance table being configured for recording an execution status of the execution instance;
the instance obtaining module 113 is configured to sequentially obtain a first function block instance associated with the execution instance in the function block instance queue as a to-be-processed function block instance; the to-be-processed function block instance being corresponding to a to-be-processed function block instance identifier and a to-be-processed function block instance index; the to-be-processed function block instance identifier and the to-be-processed function block instance index being generated when the to-be-processed function block instance is created according to a to-be-processed function code block; the target function block instance index being configured for representing a quantity of execution of the to-be-processed function code block; and the to-be-processed function code block belonging to the at least two function code blocks;
the instance execution module 114 is configured to execute the to-be-processed function block instance to obtain a target execution result; and
the table recording module 115 is configured to record the target execution result in the execution instance table according to the to-be-processed function block instance identifier and the to-be-processed function block instance index.

For specific implementations of the table creation module 112, the instance obtaining module 113, the instance execution module 114, and the table recording module 115, refer to specific descriptions of operation S201 to operation S205 in the foregoing embodiment corresponding to FIG. 7. Details are not described herein again.

The to-be-processed function block instance includes a requirement data obtaining path.

The instance execution module 114 includes: a container determining unit 1141 and a container execution unit 1142.

The container determining unit 1141 is configured to: query an idle status of a computing resource of an execution engine container, and identify an execution engine container with a largest idle computing resource as a target execution engine container; and
the container execution unit 1142 is configured to: transfer the to-be-processed function block instance from the function block instance queue to the target execution engine container, obtain requirement data from the target execution engine container according to the requirement data obtaining path, and execute the to-be-processed function block instance according to the requirement data to obtain the target execution result.

For specific implementations of the container determining unit 1141 and the container execution unit 1142, refer to specific descriptions of operation S204 in the embodiment corresponding to FIG. 7. Details are not described herein again.

The data processing apparatus 1 further includes: an identifier determining module 116 and an index determining module 117.

The identifier determining module 116 is configured to: obtain, when the to-be-processed function block instance corresponding to the to-be-processed function code block is created, an identifier configured for uniquely identifying the to-be-processed function code block as the to-be-processed function block instance identifier corresponding to the to-be-processed function block instance;
the index determining module 117 is configured to: determine, if the to-be-processed function block instance identifier is not found in the execution instance table, that the to-be-processed function block instance index is a default index; and
the index determining module 117 is further configured to: obtain, if the to-be-processed function block instance identifier is found in the execution instance table, a history index whose record time is the latest and associated with the to-be-processed function block instance identifier, and perform accumulative processing on the history index to obtain the to-be-processed function block instance index.

For specific implementations of the identifier determining module 116 and the index determining module 117, refer to optional descriptions of operation S205 in the embodiment corresponding to FIG. 7. Details are not described herein again.

In some embodiments, the trigger module 101 is specifically configured to:
receive a trigger request for the target workflow, and create the execution instance corresponding to the target workflow.

The trigger request includes a web page callback trigger request.

The trigger module 101 includes: a first trigger unit 1011.

The first trigger unit 1011 is configured to: receive the web page callback trigger request for the target workflow, and obtain a target token from the web page callback trigger request;
the first trigger unit 1011 is further configured to obtain the target workflow in a workflow repository according to the target token; and
the first trigger unit 1011 is further configured to create the execution instance corresponding to the target workflow according to a request parameter included in the web page callback trigger request.

For a specific implementation of the first trigger unit 1011, refer to specific descriptions of operation S101 in the embodiment corresponding to FIG. 3. Details are not described herein again.

The trigger request includes an instruction request.

The trigger module 101 includes: a second trigger unit 1012.

The second trigger unit 1012 is configured to obtain, by using a callback address, the instruction request transmitted by a first object, and decrypt the instruction request to obtain a trigger instruction and a trigger parameter;
the second trigger unit 1012 is further configured to: obtain the target workflow according to the trigger instruction, and verify a trigger permission of the first object according to the trigger parameter; and
the second trigger unit 1012 is further configured to: create the execution instance corresponding to the target workflow if the trigger permission of the first object is a qualified permission.

For a specific implementation of the second trigger unit 1012, refer to specific descriptions of operation S101 in the embodiment corresponding to FIG. 3. Details are not described herein again.

The trigger request includes a timer trigger request.

The trigger module 101 includes: a third trigger unit 1013.

The third trigger unit 1013 is configured to: receive the timer trigger request for the target workflow, and obtain a specified execution time from the timer trigger request; and
the third trigger unit 1013 is further configured to: create the execution instance corresponding to the target workflow when system time is the same as the specified execution time.

For a specific implementation of the third trigger unit 1013, refer to specific descriptions of operation S101 in the embodiment corresponding to FIG. 3. Details are not described herein again.

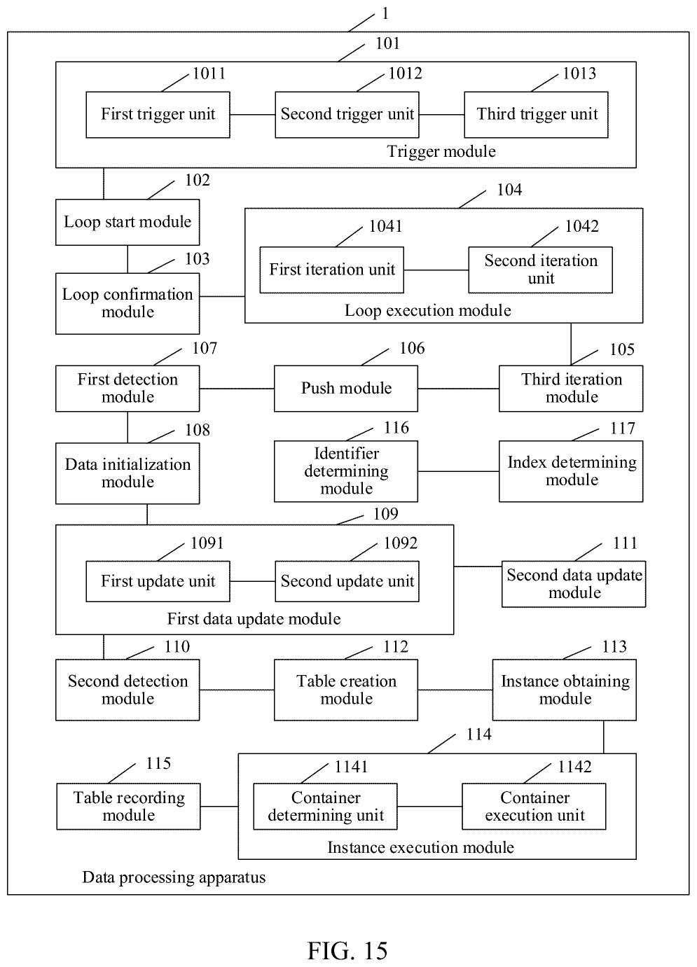

Referring to FIG. 16, FIG. 16 is a schematic structural diagram of a computer device according to an embodiment of this application. As shown in FIG. 16, the data processing apparatus 1 in the foregoing embodiment corresponding to FIG. 15 may be applied to a computer device 1000, and the computer device 1000 may include: a processor 1001, a network interface 1004, and a memory 1005. In addition, the foregoing computer device 1000 may further include: a user interface 1003 and at least one communication bus 1002. The communication bus 1002 is configured to implement connection and communication between these components. The user interface 1003 may include a display and a keyboard. In one embodiment, the user interface 1003 may further include a standard wired interface and wireless interface. In some embodiments, the network interface 1004 may include a standard wired interface and wireless interface (for example, a Wi-Fi interface). The memory 1005 may be a high-speed RAM memory, or may be a non-volatile memory, for example, at least one magnetic disk memory. In some embodiments, the memory 1005 may be at least one storage apparatus that is located far away from the foregoing processor 1001. As shown in FIG. 16, the memory 1005 used as a computer readable storage medium may include an operating system, a network communication module, a user interface module, and a device-control application program.

In the computer device 1000 shown in FIG. 16, the network interface 1004 may provide a network communication network element. The user interface 1003 is mainly configured to provide an input interface for a user. The processor 1001 may be configured to invoke a device-control application program stored in the memory 1005, so as to implement the foregoing description of the data processing method in any one of the embodiments corresponding to FIG. 3 and FIG. 7. Details are not described herein again. In addition, the description of beneficial effects of the same method is not described herein again.

In addition, an embodiment of this application further provides a computer readable storage medium. The computer readable storage medium stores a computer program executed by the data processing apparatus 1 mentioned above, and the computer program includes program instructions. When the processor executes the program instructions, the processor can execute the foregoing description of the data processing method in the embodiment corresponding to FIG. 3 and FIG. 7. Therefore, details are not described herein again. In addition, the description of beneficial effects of the same method is not described herein again. For technical details that are not disclosed in the computer readable storage medium embodiments of this application, refer to the descriptions of the method embodiments of this application.

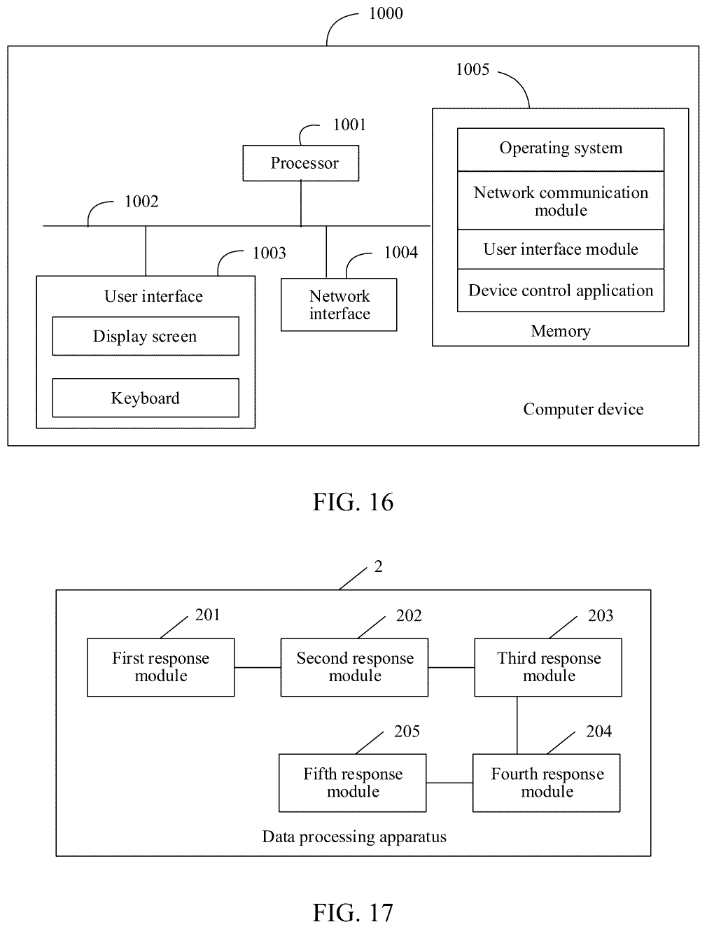

Further, referring to FIG. 17, FIG. 17 is a schematic structural diagram of a data processing apparatus according to an embodiment of this application. The foregoing data processing apparatus may be a computer program (including program code) running in a computer device. For example, the data processing apparatus is application software. The apparatus may be configured to perform corresponding operations in the method provided in the embodiment of this application. As shown in FIG. 17, the data processing apparatus 2 may include: a first response module 201, a second response module 202, a third response module 203, a fourth response module 204, and a fifth response module 205.

The first response module 201 is configured to display a workflow editing page in response to a creation operation for a target workflow;
the second response module 202 is configured to display, on the workflow editing page, a workflow control tree formed by at least two function block controls in response to a selection and connection operation for the at least two function block controls; the at least two function block controls including a loop start function block control and a loop end function block control;
the third response module 203 is configured to set a loop parameter for the loop start function block control in response to a trigger operation for the loop start function block control in the workflow control tree;
the fourth response module 204 is configured to create a target workflow in response to a creation operation for the workflow control tree, and transmit the target workflow to a workflow engine; the target workflow including function code blocks respectively corresponding to the at least two function block controls; a pointing relationship between the at least two function code blocks being determined according to a connection relationship between the at least two function block controls; and the at least two function code blocks including a loop start function code block corresponding to the loop start function block control and a loop end function code block corresponding to the loop end function block control; and
the fifth response module 205 is configured to transmit a trigger request for the target workflow to the workflow engine in response to a trigger operation for the target workflow.

For specific implementations of the first response module 201, the second response module 202, the third response module 203, the fourth response module 204, and the fifth response module 205, refer to specific descriptions of operation S301 to operation S305 in the foregoing embodiment corresponding to FIG. 13. Details are not described herein again.

In some embodiments, the third response module 203 is specifically configured to:
display a loop editing text box in response to a trigger operation for the loop start function block control in the workflow control tree, and set a loop parameter for the loop start function block control in response to an input operation for the loop editing text box.

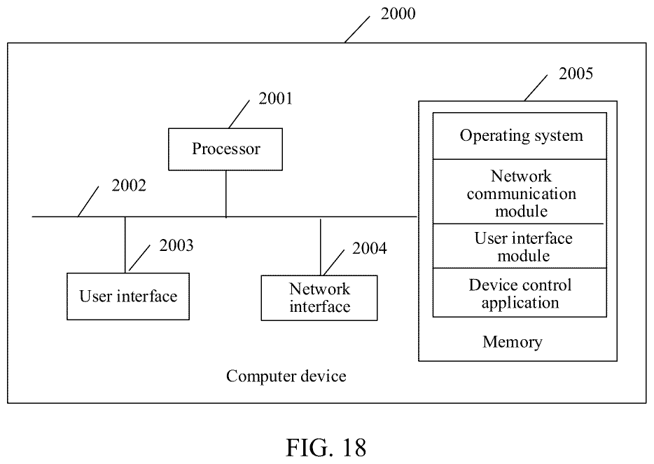

Further, referring to FIG. 18, FIG. 18 is a schematic structural diagram of another computer device according to an embodiment of this application. As shown in FIG. 18, the data processing apparatus 2 in the foregoing embodiment corresponding to FIG. 17 may be applied to a computer device 2000, and the computer device 2000 may include: a processor 2001, a network interface 2004, and a memory 2005. In addition, the foregoing computer device 2000 further includes: a user interface 2003 and at least one communication bus 2002. The communication bus 2002 is configured to implement connection and communication between these components. The user interface 2003 may include a display and a keyboard. In one embodiment, the user interface 2003 may further include a standard wired interface and wireless interface. In some embodiments, the network interface 2004 may include a standard wired interface and wireless interface (for example, a Wi-Fi interface). The memory 2005 may be a high-speed RAM memory, or may be a non-volatile memory, for example, at least one magnetic disk memory. In some embodiments, the memory 2005 may be at least one storage apparatus that is located far away from the foregoing processor 2001. As shown in FIG. 18, the memory 2005 used as a computer readable storage medium may include an operating system, a network communication module, a user interface module, and a device-control application program.

In the computer device 2000 shown in FIG. 18, the network interface 2004 may provide a network communication function. The user interface 2003 is mainly configured to provide an input interface for a user. The processor 2001 may be configured to invoke a device-control application program stored in the memory 2005 to implement description of the data processing method in the foregoing embodiments, or may execute description of the data processing apparatus 2 in the foregoing embodiments corresponding to FIG. 13. Details are not described herein again. In addition, the description of beneficial effects of the same method is not described herein again.

In addition, an embodiment of this application further provides a computer readable storage medium, and the computer readable storage medium stores a computer program executed by the foregoing data processing apparatus 2. When the processor loads and executes the foregoing computer program, the processor can execute the foregoing description of the data processing method in any embodiment of the foregoing. Therefore, details are not described herein again. In addition, the description of beneficial effects of the same method is not described herein again. For technical details that are not disclosed in the computer readable storage medium embodiments of this application, refer to the descriptions of the method embodiments of this application.

The foregoing computer readable storage medium may be the data processing apparatus provided in any one of the foregoing embodiments or an internal storage unit of the foregoing computer device, such as a hard disk or a memory of the computer device. The computer readable storage medium may also be an external storage device of the computer device, for example, a plug type hard disk, a smart media card (SMC), a secure digital (SD) card, and a flash card that are configured on the computer device. Further, the computer readable storage medium may further include an internal storage unit of the computer device and an external storage device. The computer readable storage medium is configured to store the computer program and other programs and data required by the computer device. The computer readable storage medium may be further configured to temporarily store data that has been or is to be output.

In addition, an embodiment of this application provides a computer program product or a computer program. The computer program product or the computer program includes computer instructions, and the computer instructions are stored in a computer readable storage medium. A processor of a computer device reads the computer instructions from the computer readable storage medium, and the processor executes the computer instructions, so that the computer device executes the method provided in any one of the foregoing corresponding embodiments.

The terms “first” and “second” in the specification, claims, and accompanying drawings of the embodiments of this application are configured for distinguishing between different objects, and are not configured for describing a specific sequence. In addition, the term “include” and any variant thereof are intended to cover a non-exclusive inclusion. For example, a process, method, apparatus, product, or device that includes a series of operations or units is not limited to the listed operations or modules; and instead, in some embodiments, further includes an operation or module that is not listed, or in some embodiments, further includes another operation or unit that is intrinsic to the process, method, apparatus, product, or device.

A person of ordinary skill in the art may be aware that, in combination with the examples described in the embodiments disclosed in this specification, units and algorithm operations may be implemented by electronic hardware, computer software, or a combination thereof. To clearly describe the interchangeability between the hardware and the software, the foregoing has generally described compositions and operations of each example according to network elements. Whether the network elements are executed in a mode of hardware or software depends on particular applications and design constraint conditions of the technical solutions. Those skilled in the art may use different methods to implement the described network elements for each particular application, but such implementation is not to be considered beyond the scope of this application.

What is disclosed above is merely embodiments of this application, and certainly is not intended to limit the scope of the claims of this application. Therefore, equivalent variations made in accordance with the claims of this application shall fall within the scope of this application.

What is claimed is:

1. A data processing method, performed by a computer device, comprising:
creating an execution instance corresponding to a target workflow, the execution instance comprising a pointing relationship between at least two function code blocks comprised in the target workflow, and the at least two function code blocks comprising a loop start function code block and a loop end function code block;
obtaining a loop parameter corresponding to the loop start function code block;
determining a function code block between the loop start function code block and the loop end function code block as a loop function code block according to the pointing relationship; and
looping the loop function code block according to the loop parameter and the pointing relationship.

2. The method according to claim 1, wherein the obtaining a loop parameter corresponding to the loop start function code block comprises:
creating a loop start function block instance corresponding to the loop start function code block, pushing the loop start function block instance to a function block instance queue, and when execution of the loop start function block instance in the function block instance queue succeeds, obtaining the loop parameter corresponding to the loop start function code block; and
the looping the loop function code block according to the loop parameter and the pointing relationship comprises:
looping the loop function code block according to the loop parameter, the function block instance queue, and the pointing relationship.

3. The method according to claim 2, wherein the loop parameter is N, and N is a positive integer greater than or equal to 1; and the looping the loop function code block according to the loop parameter, the function block instance queue, and the pointing relationship comprises:
determining, according to the pointing relationship in a kth round of iteration on the loop function code block, a list of to-be-executed function code blocks to which the loop start function code block points, k being a positive integer less than or equal to N;
determining, if the list of to-be-executed function code blocks does not comprise the loop end function code block and a target to-be-executed function block instance corresponding to a target to-be-executed function code block in the function block instance queue is executed successfully, a new list of to-be-executed function code blocks to which the target to-be-executed function code block points according to the pointing relationship until it is determined that the kth round of iteration on the loop function code block is completed, the target to-be-executed function code block being a function code block in the list of to-be-executed function code blocks; and
continuing to perform a (k+1)th round of iteration on the loop function code block if k is less than N.

4. The method according to claim 3, further comprising:
querying a loop end function block instance queue if the new list of to-be-executed function code blocks comprises the loop end function code block, or if the loop end function block instance queue is an empty queue, pushing a loop end function block instance corresponding to the loop end function code block to the loop end function block instance queue;
determining, if execution data of the execution instance meets an execution end condition, that the kth round of iteration on the loop function code block is completed;
pushing the loop end function block instance in the loop end function block instance queue to the function block instance queue, when an Nth round of iteration on the loop function code block is completed, to detect new execution data of the execution instance; and
determining that execution of the at least two function code blocks is completed, if the new execution data meets the execution end condition and the loop end function block instance queue is an empty queue.

5. The method according to claim 1, wherein the execution data of the execution instance comprises a quantity of instances in queue and a quantity of instances in execution; and
the method further comprises:
initializing the quantity of instances in queue as a first default parameter while the execution instance is created, and initializing the quantity of instances in execution as a second default parameter;
accumulating or decrementing the quantity of instances in queue according to an execution status of a function block instance associated with the execution instance, and accumulating or decrementing the quantity of instances in execution; and
determining, if the quantity of instances in queue is equal to the first default parameter, and the quantity of instances in execution is equal to the second default parameter, that the execution data of the execution instance is detected to meet the execution end condition.

6. The method according to claim 5, wherein the function block instance associated with the execution instance comprises a target function block instance; and
the performing, according to an execution status of a function block instance associated with the execution instance, accumulative processing or decrementing processing on the quantity of instances in queue, and accumulating or decrementing the quantity of instances in execution comprises:
accumulating the queue instance data when the target function block instance is pushed to the function block instance queue; and
accumulating the quantity of instances in execution when the target function block instance in the function block instance queue is executed, and decrementing the quantity of instances in queue.

7. The method according to claim 6, further comprising:
determining a creation status of a new target function block instance when execution of the target function block instance is completed;
decrementing the quantity of instances in execution if the new target function block instance is successfully created, and a function code block corresponding to the new target function block instance is the loop end function code block;
if the new target function block instance is successfully created and the function code block corresponding to the new target function block instance is not the loop end function code block, after the new target function block instance is pushed to the function block instance queue, accumulating the quantity of instances in queue according to a quantity of the new target function block instance, and decrementing the quantity of instances in execution; and
decrementing the quantity of instances in execution if creation of the new target function block instance fails.

8. The method according to claim 2, further comprising:
creating an execution instance table corresponding to the execution instance while the execution instance corresponding to the target workflow is created, the execution instance table being configured for recording an execution status of the execution instance;
sequentially obtaining a first function block instance associated with the execution instance in the function block instance queue as a to-be-processed function block instance, the to-be-processed function block instance being corresponding to a to-be-processed function block instance identifier and a to-be-processed function block instance index, the to-be-processed function block instance identifier and the to-be-processed function block instance index being generated when the to-be-processed function block instance is created according to a to-be-processed function code block, the target function block instance index being configured for representing a quantity of execution of the to-be-processed function code block, and the to-be-processed function code block belonging to the at least two function code blocks;
executing the to-be-processed function block instance to obtain a target execution result; and
recording the target execution result in the execution instance table according to the to-be-processed function block instance identifier and the to-be-processed function block instance index.

9. The method according to claim 8, wherein the to-be-processed function block instance comprises a requirement data obtaining path; and
the executing the to-be-processed function block instance to obtain a target execution result comprises:
querying an idle status of a computing resource of an execution engine container, and identifying an execution engine container with a largest idle computing resource as a target execution engine container; and
transferring the to-be-processed function block instance from the function block instance queue to the target execution engine container, obtaining requirement data from the target execution engine container according to the requirement data obtaining path, and executing the to-be-processed function block instance according to the requirement data to obtain the target execution result.

10. The method according to claim 8, further comprising:
obtaining an identifier configured for uniquely identifying the to-be-processed function code block as the to-be-processed function block instance identifier corresponding to the to-be-processed function block instance when the to-be-processed function block instance corresponding to the to-be-processed function code block is created;
determining that the to-be-processed function block instance index is a default index if the to-be-processed function block instance identifier is not found in the execution instance table; and
obtaining a history index whose record time is the latest and associated with the to-be-processed function block instance identifier if the to-be-processed function block instance identifier is found in the execution instance table, and performing accumulative processing on the history index to obtain the to-be-processed function block instance index.

11. The method according to claim 1, wherein the creating an execution instance corresponding to a target workflow comprises:
receiving a trigger request for the target workflow, and creating the execution instance corresponding to the target workflow.

12. The method according to claim 11, wherein the trigger request comprises a web page callback trigger request; and
the receiving a trigger request for the target workflow, and creating the execution instance corresponding to the target workflow comprises:
receiving the web page callback trigger request for the target workflow, and obtaining a target token from the web page callback trigger request;
obtaining the target workflow in a workflow repository according to the target token; and
creating the execution instance corresponding to the target workflow according to a request parameter comprised in the web page callback trigger request.

13. The method according to claim 11, wherein the trigger request comprises an instruction request; and
the receiving a trigger request for the target workflow, and creating the execution instance corresponding to the target workflow comprises:
obtaining, the instruction request transmitted by a first object by using a callback address, and decrypting the instruction request to obtain a trigger instruction and a trigger parameter;
obtaining the target workflow according to the trigger instruction, and verifying a trigger permission of the first object according to the trigger parameter; and
creating the execution instance corresponding to the target workflow if the trigger permission of the first object is a qualified permission.

14. The method according to claim 11, wherein the trigger request comprises a timer trigger request; and
the receiving a trigger request for the target workflow, and creating the execution instance corresponding to the target workflow comprises:
receiving the timer trigger request for the target workflow, and obtaining a specified execution time from the timer trigger request; and
creating the execution instance corresponding to the target workflow when system time is the same as the specified execution time.

15. A data processing method, performed by a computer device, comprising:
displaying a workflow editing page in response to a creation operation for a target workflow;
displaying a workflow control tree formed by at least two function block controls on the workflow editing page in response to a selection and connection operation for the at least two function block controls, the at least two function block controls comprising a loop start function block control and a loop end function block control;
setting a loop parameter for the loop start function block control in response to a trigger operation for the loop start function block control in the workflow control tree;
creating a target workflow in response to a creation operation for the workflow control tree, and transmitting the target workflow to a workflow engine, the target workflow comprising function code blocks respectively corresponding to the at least two function block controls with a pointing relationship being determined according to a connection relationship between the at least two function block controls, and the at least two function code blocks comprising a loop start function code block corresponding to the loop start function block control and a loop end function code block corresponding to the loop end function block control; and
transmitting a trigger request for the target workflow to the workflow engine in response to a trigger operation for the target workflow.

16. A computer device, comprising: a processor, a memory, and a network interface;
the processor being connected to the memory and the network interface, the network interface being configured to provide a data communication function, the memory being configured to store program code, and the processor being configured to invoke the program code to perform a data processing method, performed by a computer device, comprising:
creating an execution instance corresponding to a target workflow, the execution instance comprising a pointing relationship between at least two function code blocks comprised in the target workflow, and the at least two function code blocks comprising a loop start function code block and a loop end function code block;
obtaining a loop parameter corresponding to the loop start function code block;
determining a function code block between the loop start function code block and the loop end function code block as a loop function code block according to the pointing relationship; and
looping the loop function code block according to the loop parameter and the pointing relationship.

17. The computer device according to claim 16, wherein the obtaining a loop parameter corresponding to the loop start function code block comprises:
creating a loop start function block instance corresponding to the loop start function code block, pushing the loop start function block instance to a function block instance queue, and when execution of the loop start function block instance in the function block instance queue succeeds, obtaining the loop parameter corresponding to the loop start function code block; and
the looping the loop function code block according to the loop parameter and the pointing relationship comprises:
looping the loop function code block according to the loop parameter, the function block instance queue, and the pointing relationship.

18. The computer device according to claim 17, wherein the loop parameter is N, and N is a positive integer greater than or equal to 1; and the looping the loop function code block according to the loop parameter, the function block instance queue, and the pointing relationship comprises:
determining, according to the pointing relationship in a kth round of iteration on the loop function code block, a list of to-be-executed function code blocks to which the loop start function code block points, k being a positive integer less than or equal to N;
determining, if the list of to-be-executed function code blocks does not comprise the loop end function code block and a target to-be-executed function block instance corresponding to a target to-be-executed function code block in the function block instance queue is executed successfully, a new list of to-be-executed function code blocks to which the target to-be-executed function code block points according to the pointing relationship until it is determined that the kth round of iteration on the loop function code block is completed, the target to-be-executed function code block being a function code block in the list of to-be-executed function code blocks; and
continuing to perform a (k+1)th round of iteration on the loop function code block if k is less than N.

19. The computer device according to claim 18, further comprising:
querying a loop end function block instance queue if the new list of to-be-executed function code blocks comprises the loop end function code block, or if the loop end function block instance queue is an empty queue, pushing a loop end function block instance corresponding to the loop end function code block to the loop end function block instance queue;
determining, if execution data of the execution instance meets an execution end condition, that the kth round of iteration on the loop function code block is completed;
pushing the loop end function block instance in the loop end function block instance queue to the function block instance queue, when an Nth round of iteration on the loop function code block is completed, to detect new execution data of the execution instance; and
determining that execution of the at least two function code blocks is completed, if the new execution data meets the execution end condition and the loop end function block instance queue is an empty queue.

20. The computer device according to claim 16, wherein the execution data of the execution instance comprises a quantity of instances in queue and a quantity of instances in execution; and
the method further comprises:
initializing the quantity of instances in queue as a first default parameter while the execution instance is created, and initializing the quantity of instances in execution as a second default parameter;
accumulating or decrementing the quantity of instances in queue according to an execution status of a function block instance associated with the execution instance, and accumulating or decrementing the quantity of instances in execution; and
determining, if the quantity of instances in queue is equal to the first default parameter, and the quantity of instances in execution is equal to the second default parameter, that the execution data of the execution instance is detected to meet the execution end condition.
